(19) United States
(12) Patent Application Publication
(10) Pub. No.: US 2026/0041301 A1
(43) Pub. Date: Feb. 12, 2026

(54) CONVEYOR DEVICE AND ALIGNING DEVICE

(71) Applicant: Kura Sushi, Inc., Osaka (JP)

(72) Inventors: Kunihiko TANAKA, Osaka (JP); Naoki Sakamoto, Osaka (JP)

(21) Appl. No.: 19/365,085

(22) Filed: Oct. 21, 2025

Related U.S. Application Data
(63) Continuation of application No. PCT/JP2025/001894, filed on Jan. 22, 2025.

(30) Foreign Application Priority Data
Jan. 30, 2024 (JP) 2024-012189
Jan. 30, 2024 (JP) 2024-012234
Mar. 7, 2024 (JP) 2024-035292

(51) Int. Cl. A47L 15/24; A47L 15/39; B65G 15/44; B65G 15/60; B65G 47/90

(52) U.S. Cl. CPC A47L 15/248; A47L 15/39; B65G 15/44; B65G 15/60; B65G 47/90

(57) ABSTRACT

A conveyor device includes: a first rotating body; a second rotating body; an endless belt entrained between the first rotating body and the second rotating body; and a plurality of engaging portions provided on a surface of the endless belt and engageable with the first plates. The conveyor device further includes: a first portion including the first rotating body and located mainly in water of the water tank; and a second portion including the second rotating body and located mainly above the water of the water tank. In the first portion, the endless belt is configured to move upward at a first angle with respect to a water surface of the water tank. In the second portion, the endless belt is configured to move upward at a second angle larger than the first angle with respect to the water surface of the water tank.

### CROSS REFERENCE TO RELATED APPLICATION

This application is a continuation application of International Patent Application No. PCT/JP2025/001894 filed on Jan. 22, 2025, which designated the U.S. and claims the benefit of priority from Japanese Patent Application No. 2024-012189 filed on Jan. 30, 2024, Japanese Patent Application No. 2024-012234 filed on Jan. 30, 2024, and Japanese Patent Application No. 2024-035292 filed on Mar. 7, 2024. The entire disclosure of the above applications is incorporated herein by reference.

### TECHNICAL FIELD

The present disclosure relates to a conveyor device that conveys a first plate, which is a conveyance target accumulated in a water tank, upward from the water tank. The present disclosure also relates to an aligning device for aligning a plate including a circular dish body and a foot provided on a lower surface of the dish body, wherein the center of gravity of the plate is biased toward the foot side.

### BACKGROUND

Patent Literature 1 (JP 2020-089426 A) discloses a system for lifting plates accumulated in a water tank. In this system, a conveyor for lifting plates and a means for generating a water flow for collecting plates at the starting point of the conveyor are provided. As one form of a plate for a food, a plate having a planar plate body and a foot fixed to a lower surface of the plate body is used. Patent Literature 2 (JP 2014-065555 A) discloses a plate reversing apparatus for aligning orientations of plates when they pass through a conveyor. In the plate reversing apparatus, when a plate conveyed by the conveyor is in a state in which the plate body faces upward, the plate is allowed to pass in that state, and when the foot faces upward, the plate is lifted by a path changing member and reversed by a plate reversing portion so that the plate body faces upward. Accordingly, all plates that have passed through the plate reversing apparatus are conveyed in a state in which the plate body faces upward.

### SUMMARY

However, in the system of Patent Literature 1, since the system is configured to lift all the plates accumulated in the water tank, it is not possible to lift a particular plate. The present disclosure has been made to solve the above problem, and a first objective thereof is to provide a conveyor device capable of lifting a specific plate from among plates accumulated in the water tank. In addition, in the plate reversing device of Patent Literature 2, when the plate body is in a state of facing upward, the shape and position of the path changing member and the plate reversing portion are adjusted so that the plate passes between the path changing member and the plate reversing portion. Therefore, the shapes of plates usable for the plate reversing device are limited, and for example, plates having an outer diameter other than a specified outer diameter cannot be used. The present disclosure has been made to solve the above problem, and a second objective thereof is to provide an aligning device capable of conveying plates with orientations aligned regardless of various outer diameters of the plates.

First aspect: A conveyor device that conveys upward, from a water tank, first plates among the first plates and second plates accumulated in the water tank, the conveyor device comprising:
a first rotating body disposed at a start end side of the conveyor device;
a second rotating body disposed at a terminal end side of the conveyor device;
an endless belt entrained between the first rotating body and the second rotating body; and
a plurality of protrusions provided on a surface of the endless belt and engageable with the first plates and the second plates, wherein
the conveyor device further comprises:
   a first portion including the first rotating body and located mainly in water of the water tank; and
   a second portion including the second rotating body and located mainly above the water of the water tank,
in the first portion, the endless belt is configured to move upward at a first angle with respect to a water surface of the water tank,
in the second portion, the endless belt is configured to move upward at a second angle larger than the first angle with respect to the water surface, and
in the second portion, the second angle is set such that
   a virtual line extending vertically downward from a center of gravity of the first plate engaged with the protrusion intersects the surface of the endless belt within a region where the first plate is positioned, and
   a virtual line extending vertically downward from a center of gravity of the second plate engaged with the protrusion intersects the surface of the endless belt outside a region where the second plate is positioned.

Second aspect: The conveyor device according to the first aspect, wherein
each of the protrusions is formed in an arc-shape that is convex downward to receive the first plates.

Third aspect: The conveyor device according to the first aspect, further comprising
a removing member separated away a predetermined distance from the surface of the endless belt in the second portion, wherein
the second plate is removed from the endless belt by the removing member when the second plate is brought into contact with the removing member.

Fourth aspect: The conveyor device according to the first aspect, wherein
at an upper end of the second portion, the endless belt extends in a horizontal direction.

Fifth aspect: The conveyor device according to the first aspect, further comprising
a guide member configured to guide an orientation of the first plate so that the first plate conveyed upward by the endless belt in the second portion falls in a predetermined direction downward when the first plate is removed from the endless belt near the upper end of the second portion.

Sixth aspect: The conveyor device according to the first aspect, wherein
in the second portion, the second angle is set such that
   the virtual line extending vertically downward from the center of gravity of the first plate engaged with the protrusion intersects the surface of the endless belt at a position above an engagement position between the first plate and the protrusion, and
   the virtual line extending vertically downward from the center of gravity of the second plate engaged with the protrusion intersects the surface of the endless belt at a position below an engagement position between the second plate and the protrusion.

Seventh aspect: The conveyor device according to the first aspect, further comprising
a pressing roller disposed between the first portion and the second portion, wherein
the pressing roller is configured to press the endless belt to change an angle of the endless belt between the first portion and the second portion.

Eighth aspect: The conveyor device according to the first aspect, wherein
the endless belt extends linearly in plan view from a lower end of the first portion to an upper end of the second portion.

Ninth aspect: The conveyor device according to the first aspect, wherein
the water tank is connected to a downstream end of a plate collection water channel laid in an interior of a restaurant for collecting the first plates and the second plates, and
the first plates and the second plates conveyed by the plate collection water channel are accumulated in the water tank.

Tenth aspect: A conveyor device that conveys first plates accumulated in a water tank upward from the water tank, the conveyor device comprising:
a first rotating body disposed at a starting end side of the conveyor device;
a second rotating body disposed at a terminal end side of the conveyor device;
an endless belt entrained between the first rotating body and the second rotating body; and
a plurality of engaging portions provided on a surface of the endless belt and engageable with the first plates; wherein
the conveyor device further comprises:
   a first portion including the first rotating body and located mainly in water of the water tank; and
   a second portion including the second rotating body and located mainly above the water of the water tank,
in the first portion, the endless belt is configured to move upward at a first angle with respect to a water surface of the water tank, and
in the second portion, the endless belt is configured to move upward at a second angle larger than the first angle with respect to the water surface of the water tank.

Eleventh aspect: The conveyor device according to the tenth aspect, wherein
the conveyor device is configured to convey upward the first plates among the first plates and second plates accumulated in the water tank,
the plurality of engaging portions are provided on the surface of the endless belt and are engageable with the first plates and the second plates, and
a removing member is provided in the second portion to remove the second plate moving upward on the endless belt at the second angle from the endless belt.

Twelfth aspect: An aligning device for aligning plates each having a circular plate body and a foot provided on a lower surface of the plate body, the plate having a center of gravity at a position biased toward the foot, the aligning device comprising:
a first passage into which the plates are introduced; and
a second passage connected to the first passage, wherein
the first passage and the second passage are formed to extend obliquely from top to bottom in this order and to allow the plates to pass therethrough,
the first passage includes a first bottom surface having a width larger than a height of the plate, and a pair of first side surfaces rising from both sides of the first bottom surface,
the plate is introduced into the first passage from an upper side with a radial direction of the plate body extending downward,
the second passage includes a second bottom surface connected to the first bottom surface, and a pair of second side surfaces provided on both sides of the second bottom surface, and
the pair of second side surfaces have an interval therebetween that gradually widens downward.

Thirteenth aspect: The aligning device according to the twelfth aspect, further comprising
a third passage connected to the second passage, wherein
the plates pass through the third passage after the second passage,
the third passage extends obliquely from top to bottom and includes a pair of guide rails spatially arranged with each other, and
the plate passes through the third passage while both sides of the plate body are being supported by the pair of guide rails of the third passage.

Fourteenth aspect: The aligning device according to the twelfth aspect, wherein
upper ends of the pair of first side surfaces in the first passage are curved in different directions to be spaced away from each other.

Fifteenth aspect: The aligning device according to the twelfth aspect, wherein
a sensor is provided in the third passage,
the sensor is configured to detect a passage time required for the plate to move for a predetermined distance in the third passage, and
when the detected passage time exceeds a predetermined value, the plates are prevented from being introduced into the first passage.

Sixteenth aspect: A transfer device for transferring at least one of plates from a discharge device that discharges a plurality of stacked plates upward, the transfer device comprising:
two or more support units supporting at least one of the discharged plates;
an adjustment unit bringing the two or more support units closer to and apart from each other in a horizontal direction;
a robot arm moving the support units;
a sensor detecting a type of the plates discharged from the discharge device; and
a control unit, wherein
each of the two or more support units comprises:
   a support portion inserted between adjacent plates of the stacked plates and supporting, from below, an upper plate among the adjacent plates;
   at least one elongated member extending upward and connected to the support portion; and
   a connecting portion connecting an upper part of the elongated member to the adjustment unit,
the control unit is configured to execute:
   a step of inserting the support portion between the adjacent plates when the sensor detects that types of the adjacent plates are different; and
   a step of driving the robot arm to move the plates located above the support portion.

Seventeenth aspect: The transfer device according to the sixteenth aspect, wherein
if the types of the adjacent plates detected by the sensor are the same for a predetermined number consecutively, the control unit is further configured to move the predetermined number of the plates.

Eighteenth aspect: The transfer device according to the sixteenth aspect, wherein
the control unit is configured to stop, for a predetermined time, discharging the plates from the discharge device when the supporting portion is inserted between the adjacent plates.

According to the conveyor device of the present disclosure, it is possible to lift a specific plate from among plates accumulated in the water tank. Further, according to the aligning device of the present disclosure, it is possible to convey plates with orientations aligned regardless of various outer diameters of the plates.

### BRIEF DESCRIPTION OF DRAWING

FIG. 1 is a schematic view of a cleaning system.

FIG. 2 is a sectional view and a plan view of a first plate.

FIG. 3 is a sectional view and a plan view of a second plate.

FIG. 4 is a sectional view and a plan view of a third plate.

FIG. 5 is a side view of the conveyor device.

FIG. 6 is a partial front view of the conveyor device.

FIG. 7 is an enlarged side view of the conveyor device.

FIG. 8 is an enlarged sectional view showing conveyance of the first plate.

FIG. 9 is an enlarged sectional view showing falling of the second plate.

FIG. 10 is a sectional view showing an operation of a removing member.

FIG. 11 is a plan view of the aligning device.

FIG. 12 is a side view of FIG. 11.

FIG. 13 is a sectional view showing a mechanism of alignment.

FIG. 14 is a sectional view showing a mechanism of alignment.

FIG. 15 is a sectional view of a third path of the aligning device.

FIG. 16 is a sectional view of the third path of the aligning device.

FIG. 17 is a perspective view of a cleaning device according to an embodiment of the present disclosure.

FIG. 18 is a sectional view of the cleaning device.

FIG. 19 is a diagram illustrating supply of the first plate.

FIG. 20 is a plan view of a conveying path.

FIG. 21 is a side view of a discharge portion.

FIG. 22 is a diagram illustrating discharge of the first plate.

FIG. 23 is a diagram illustrating discharge of the first plate.

FIG. 24 is a side view of a brush unit.

FIG. 25 is a plan view of a brush body.

FIG. 26 is a side view of a transfer device.

FIG. 27 is a plan view showing a positional relationship between a support portion of the transfer device and the first plate.

FIG. 28 is a side view illustrating an operation of the transfer device.

FIG. 29 is a side view illustrating an operation of the transfer device.

FIG. 30 is a front view showing another example of a protrusion portion of the conveyor device.

FIG. 31 is a front view showing another example of a protrusion portion of the conveyor device.

FIG. 32 is a front view showing another example of a protrusion portion of the conveyor device.

FIG. 33 is an enlarged side view showing another example of the conveyor device.

FIG. 34 is a plan view showing another example of the aligning device.

FIG. 35 is a side view of FIG. 34.

### DESCRIPTION OF EMBODIMENTS

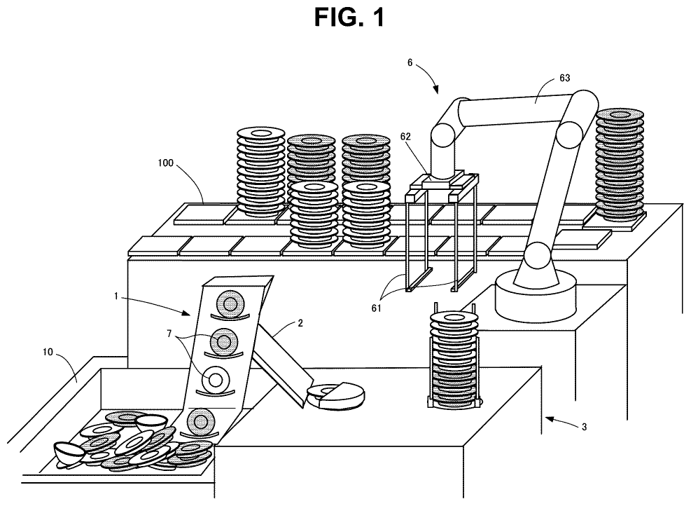

Hereinafter, an embodiment of a plate cleaning system in which a conveyor device and an aligning device according to the present disclosure are incorporated will be described with reference to the drawings. FIG. 1 is a schematic view of the cleaning system. In this embodiment, the cleaning system is installed in a restaurant or the like. As shown in FIG. 1, the plate cleaning system according to this embodiment includes a conveyor device 1, an aligning device 2, a cleaning device 3, and a transfer device 6. The cleaning system lifts the first to third plates 7 to 9 accumulated in a water tank 10, cleans them, and transfers them to a conveying path. At this time, in the conveyor device, the first and third plates are selected and conveyed, and in the aligning device 2, only the first plates 7 are selected and fed into the cleaning device 3. Thereafter, the cleaned first plates 7 are transferred to a conveying path 100 by the transfer device 6. The first plates 7 on the conveying path 100 are conveyed to a kitchen, where food and beverages are prepared and placed thereon. Here, in the restaurant, a plate collecting water channel (not shown) is laid around each table of customers. Water flows through the plate collecting water channel, and by this water flow, plates 7 to 9 after dining are conveyed. A downstream end of the plate collecting water channel is connected to the water tank 10, and the plates 7 to 9 conveyed through the plate collecting water channel are accumulated in the water tank 10. That is, the plates 7 to 9 after dining are conveyed into the plate collecting water channel and automatically accumulated in the water tank 10 without being moved manually. Control of this cleaning system is performed by a control device (not shown). The control device is not particularly limited, but may be configured by a known computer such as a PLC.

Hereinafter, the plates to be cleaned in this cleaning system and each device will be described in detail. For convenience of explanation, the following description will be made according to the directions indicated in each figure; however, the present disclosure is not limited to these directions.

### <1. Plates>

First, the first to third plates handled in the cleaning system of this embodiment will be described. The first plate 7 is a substantially flat plate for food such as sushi, the second plate 8 is a container with a deep internal space for receiving soup or the like, and the third plate 9 has the same configuration as the first plate 7 but is a small plate having a smaller outer diameter than the first plate 7, for example, a small plate for receiving soy sauce. Details will be described below.

### <1-1. First Plate and Third Plate>

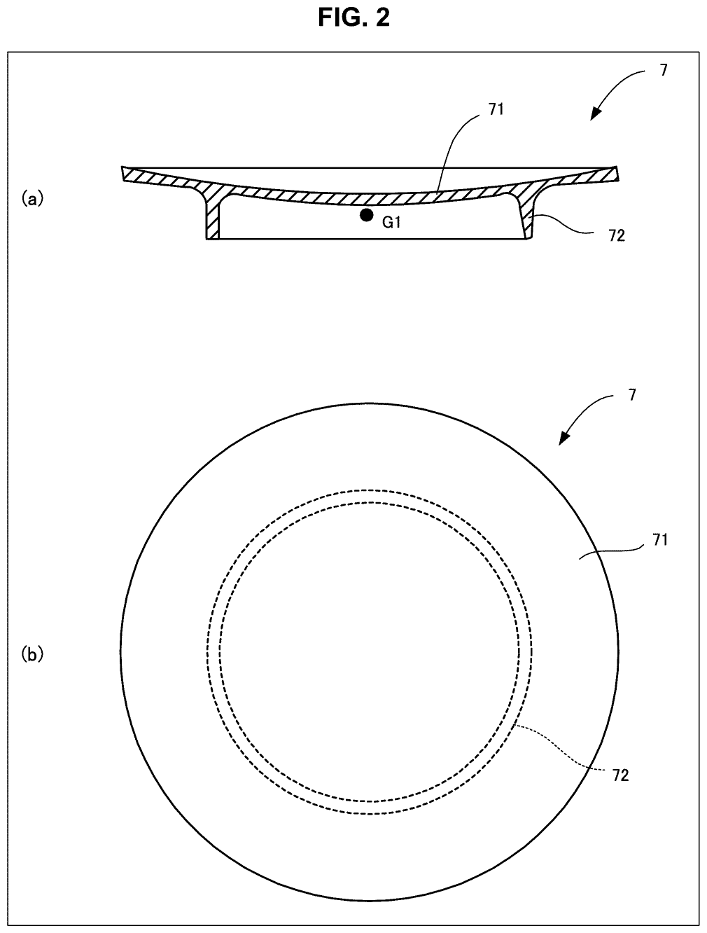

As shown in FIG. 2, the first plate (dish) 7 includes a disk-shaped plate body 71 and a cylindrical foot 72 provided on a lower surface of the plate body 71. An upper surface of the plate body 71 is formed in a curved shape convex downward. The foot 72 has an outer diameter smaller than that of the plate body 71. A center of gravity G1 of the first plate 7 is located at the foot 72, that is, in the height direction of the first plate 7, the center of gravity G1 is positioned closer to a bottom surface of the foot 72 than the center. Further, a plurality of types of the first plates 7 are prepared, for example, one having a concave portion near the center of the plate body 71 or one having a different color, but their outer diameters are generally the same. In this embodiment, it is assumed that first plates 7 having the same shape are the same color.

### <1-2. Second Plate>

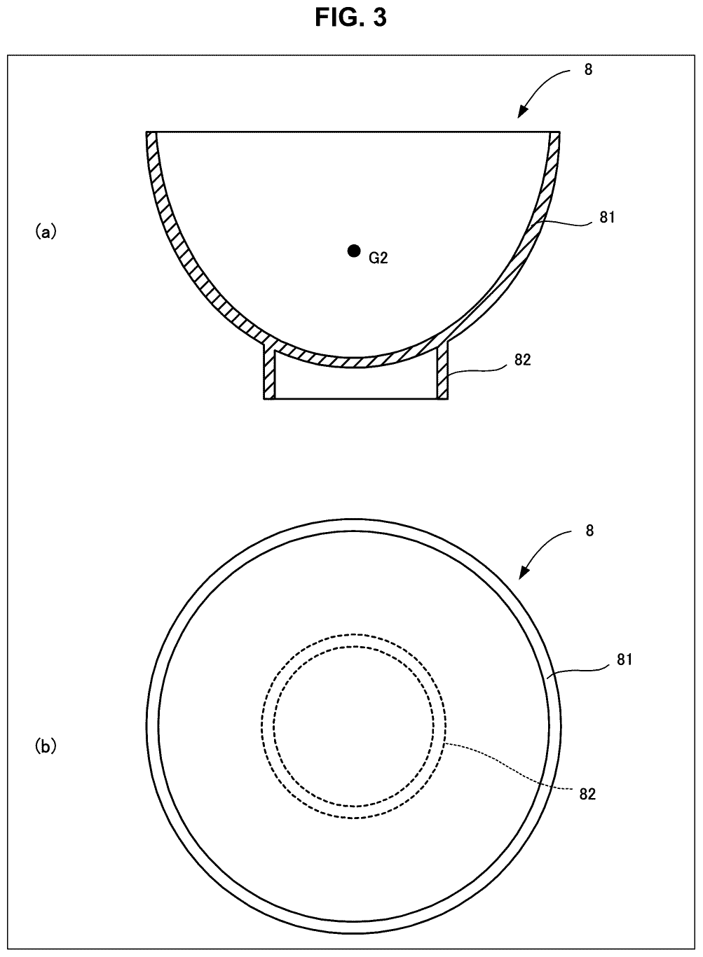

As shown in FIG. 3, the second plate 8 includes a cup-shaped body 81 having an opening at an upper portion and a foot 82 provided on a lower surface of the body 81. The body 81 has a deep internal space so as to receive soup, noodles, or rice bowls. The foot 82 is formed in a cylindrical shape, similar to the first plate 7. A center of gravity G2 of the second plate 8 is located inside the body 81, that is, in the height direction of the second plate 8, the center of gravity G2 is positioned closer to the opening side of the body 81 than the center. In addition, a plurality of types of the second plates 8 are prepared, for example, plates in which the outer diameter of the body 81 differs, the depth of the body 81 differs, the shape of the body 81 differs, or the color differs.

### <1-3. Third Plate>

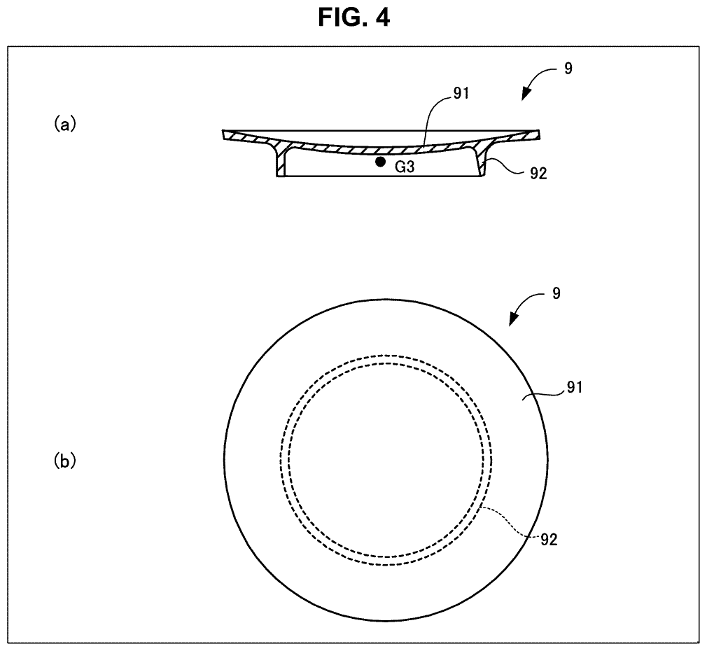

As shown in FIG. 4, the third plate 9 includes a plate body 91 and a foot 92 having the same configuration as the first plate 7, but it is a small plate with a smaller outer diameter of the plate body 91 and the foot 92 than the first plate 7.

### <2. Conveyor Device>

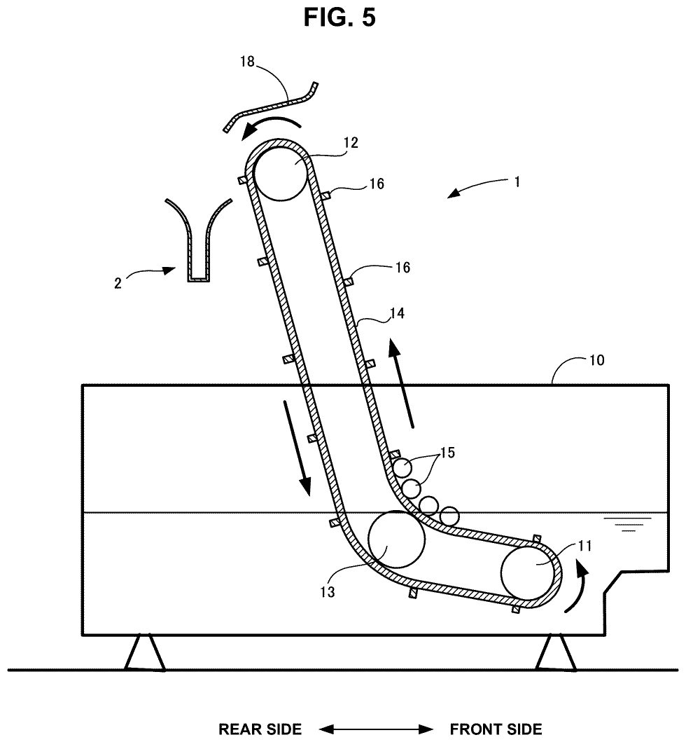

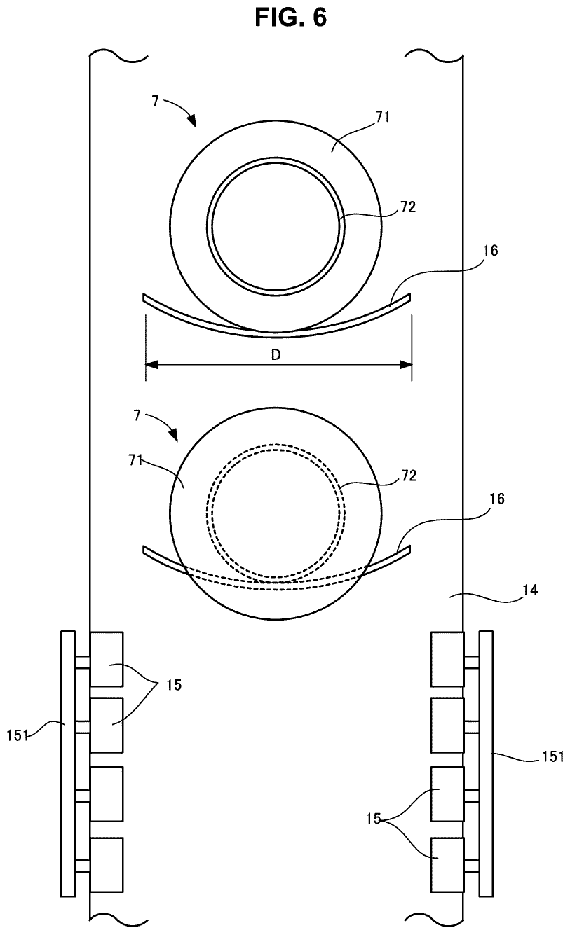

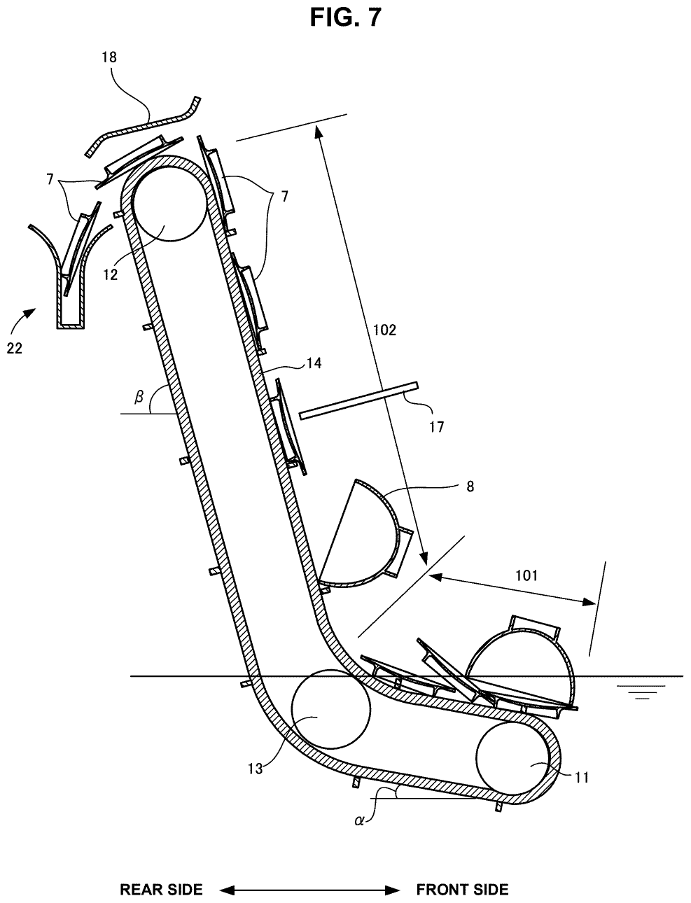

FIG. 5 is a side view of the conveyor device, FIG. 6 is a partial front view of the conveyor device, and FIG. 7 is an enlarged side view of the conveyor device. As shown in FIGS. 5 to 7, the conveyor device 1 is used to lift the first plate 7 and the third plate 9 from a water tank 10 in which used plates 7 to 9 are collected. As shown in FIG. 5, the conveyor device 1 includes a first rotating body 11 and a second rotating body 12 that are arranged at a starting end side and a terminating end side, respectively, an endless belt 14 wound around the first rotating body 11 and the second rotating body 12, and a third rotating body 13 arranged between the first rotating body 11 and the second rotating body 12. The conveyor device 1 is configured such that the conveying angle changes at the location where the third rotating body 13 is arranged.

The first rotating body 11 is arranged in the water in the water tank 10, and the second rotating body 12 is arranged above the water surface of the water tank 10. The third rotating body 13 is arranged near the water surface and engages with the endless belt 14. A motor (not shown) is connected to the second rotating body 12 and drives the endless belt 14. Meanwhile, the first rotating body 11 and the third rotating body 13 are driven rollers and rotate in accordance with the driving of the endless belt 14.

As shown in FIG. 7, the conveyor device 1 includes a first portion 101 mainly located in water of the water tank 10 and a second portion 102 mainly located above the water surface of the water tank 10. The first portion 101 is a portion between the first rotating body 11 and the third rotating body 13, and the second portion 102 is a portion between the third rotating body 13 and the second rotating body 12. A front surface of the first portion 101 forms an inclination angle α with respect to the water surface, preferably 15 to 35 degrees (more preferably 20 to 30 degrees, and 25 degrees as a specific example), and lifts plates 7 to 9 floating near the water surface. The second portion 102 is a portion continuous with the first portion 101, and on a front surface of the second portion 102, plates 7 to 9 lifted by the first portion 101 are further lifted upward. An inclination angle β of the front surface of the second portion 102 is larger than the inclination angle α of the first portion 101, preferably 70 to 90 degrees (more preferably 75 to 85 degrees, and 80 degrees as a specific example). Here, as shown in FIG. 1, the endless belt 14 extends linearly in a plan view from a lower end of the first portion 101 to an upper end of the second portion 102. Specifically, in the present embodiment, the endless belt 14 extends linearly in the front-rear direction in the plan view. Furthermore, the second portion 102 has a larger upward inclination angle than the first portion 101. As a result, a dimension of the endless belt 14 in the conveying direction (that is, the front-rear direction) of the conveyor device 1 can be reduced. Consequently, the dimension of the entire cleaning system in the front-rear direction can be suppressed.

On a front surface of the endless belt 14, at a connecting portion between the first portion 101 and the second portion 102, a plurality of pressing rollers 15 are arranged to press both sides of the endless belt 14. That is, the pressing rollers 15 are arranged at positions corresponding to the third rotating body 13. In this embodiment, four pressing rollers 15 are arranged on each side of the endless belt 14. The pressing rollers 15 are for changing an angle of the endless belt 14 between the first portion 101 and the second portion 102, and the four pressing rollers 15 are arranged in an arc along the conveying direction on both sides of the endless belt 14. The endless belt 14 is pressed by the pressing rollers 15 so as to bend in an arc from the first portion 101 to the second portion 102.

As shown in FIG. 6, on a surface of the endless belt 14, protrusions (engaging portions) 16 for supporting plates are provided at predetermined intervals along the conveying direction. Each protrusion 16 is provided near the center in the width direction of the endless belt 14. Each protrusion 16 is formed in a plate shape and is formed in an arc-shape so as to project downward on the front surface of the conveyor device 1. A height of each protrusion 16 from the surface of the endless belt 14 is lower than a height of a foot of each plate 7 to 9. Further, a radius of curvature of each protrusion 16 is larger than a radius of curvature of a plate body 71 of the first plate 7. Furthermore, a horizontal width D of each protrusion 16 is larger than a diameter of the plate body 71 of the first plate 7. Accordingly, the first plate 7 is lifted upward while being supported by an outer peripheral surface of the foot 72 or an outer edge of the plate body 71 by the protrusion 16. In this embodiment, the protrusion 16 is employed as the engaging portion for supporting plates; however, as long as a plate can be conveyed together with the endless belt 14 by engagement with the plate, other embodiments may be adopted. For example, as the engaging portion, a recess may be formed on the surface of the endless belt 14 so that a plate is engaged in the recess.

As described above, since the first portion 101 of the conveyor device 1 has a small inclination angle α, when plates 7 to 9 are caught on the endless belt 14, most of the plates 7 to 9 floating near the water surface of the water tank 10 are conveyed up to near the water surface. However, since the second portion 102 has a large inclination angle β, only the first plate 7 and the third plate 9 among the plates 7 to 9 lifted by the first portion 101 are lifted upward, while the second plate 8 falls from the endless belt 14. Thus, the conveyor device 1 is configured such that, in the first portion 101, as many plates as possible are placed on the endless belt 14, and in the second portion 102, the placed plates are sorted. However, if the inclination angle β is too small, many plates are caught by the protrusion 16, and as will be described later, the first plate 7 cannot be selected. On the other hand, if the inclination angle β is too large, the first plate 7 is also less likely to be caught by the protrusion 16, which may reduce the efficiency of lifting the first plate 7.

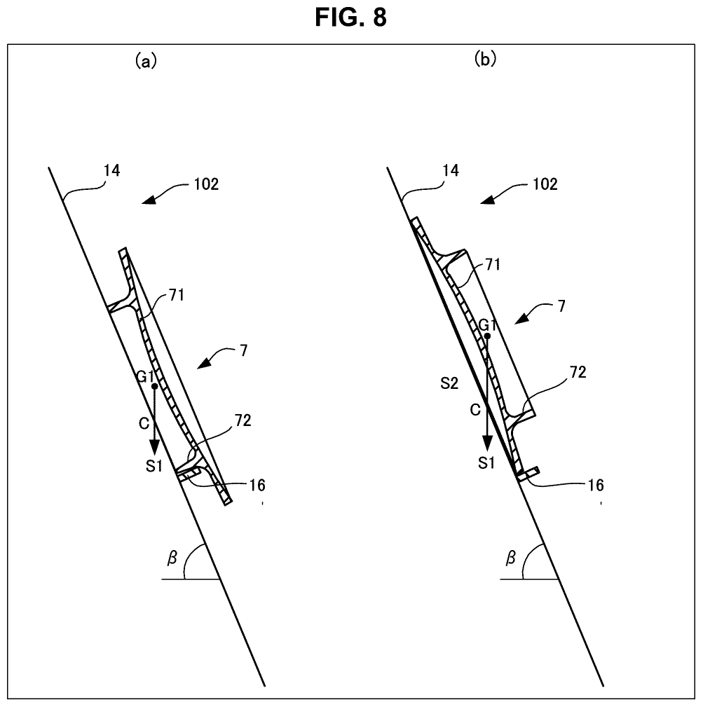

The inclination angle β of the second portion 102 of the conveyor device 1 can be determined as follows. As shown in FIG. 8, in a state where the first plate 7 is supported by the protrusion 16, a virtual line S1 extending vertically from the center of gravity G1 of the first plate 7 intersects the surface of the endless belt 14 within a region in which the first plate 7 is disposed (a region obtained by projecting the disposed first plate 7 onto the surface of the endless belt 14), at an intersection point C. In other words, the inclination angle β is set such that the virtual line extending vertically downward from the center of gravity G1 of the first plate 7 intersects the surface of the endless belt 14 above an engaging position between the first plate 7 and the protrusion 16. Thus, the first plate 7 supported by the protrusion 16 is conveyed upward without being detached (disengaged) with the protrusion 16. Since the center of gravity G3 of the third plate 9 is also located at the foot 92, the third plate 9 is conveyed upward by the second portion 102 in the same manner as the first plate 7.

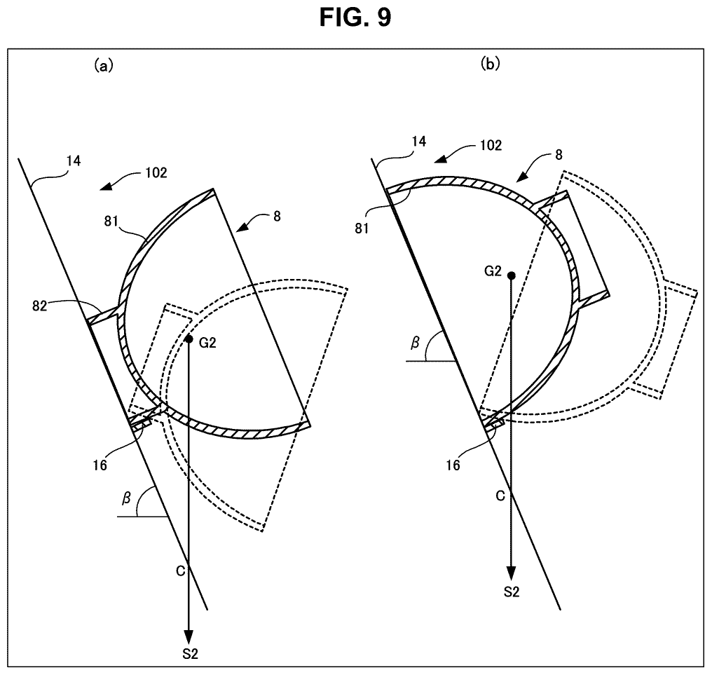

On the other hand, as shown in FIG. 9, the second plate 8 is once supported by an outer peripheral surface of the foot 82 or an opening edge portion of the body 81 at the protrusion 16, but is configured to be detached (disengaged) from the protrusion 16 in the process of being conveyed upward. That is, in a state where the second plate 8 is supported by the protrusion 16, a virtual line S2 extending vertically from the center of gravity G2 of the second plate 8 intersects the surface of the endless belt 14 outside a region in which the second plate 8 is disposed (a region obtained by projecting the disposed second plate 8 onto the surface of the endless belt 14), at an intersection point C. In other words, the inclination angle β is set such that the virtual line extending vertically downward from the center of gravity G2 of the second plate 8 intersects the surface of the endless belt 14 below an engaging position between the second plate 8 and the protrusion 16. Thus, even if the second plate 8 is once supported by the protrusion 16, the second plate 8 is detached from the protrusion 16 by the action of the center of gravity G2 and falls from the endless belt 14 into the water tank 10. Therefore, by the conveyor device 1, the first plate 7 and the third plate 9 are selected and conveyed.

Further, the conveyor device 1 is provided with a removing member 17 for detaching (removing) the second plate 8, which is unexpectedly supported by the protrusion 16 and conveyed upward, from the endless belt 14, and a guide member 18 arranged near an upper end of the conveyor device 1. These will be described below.

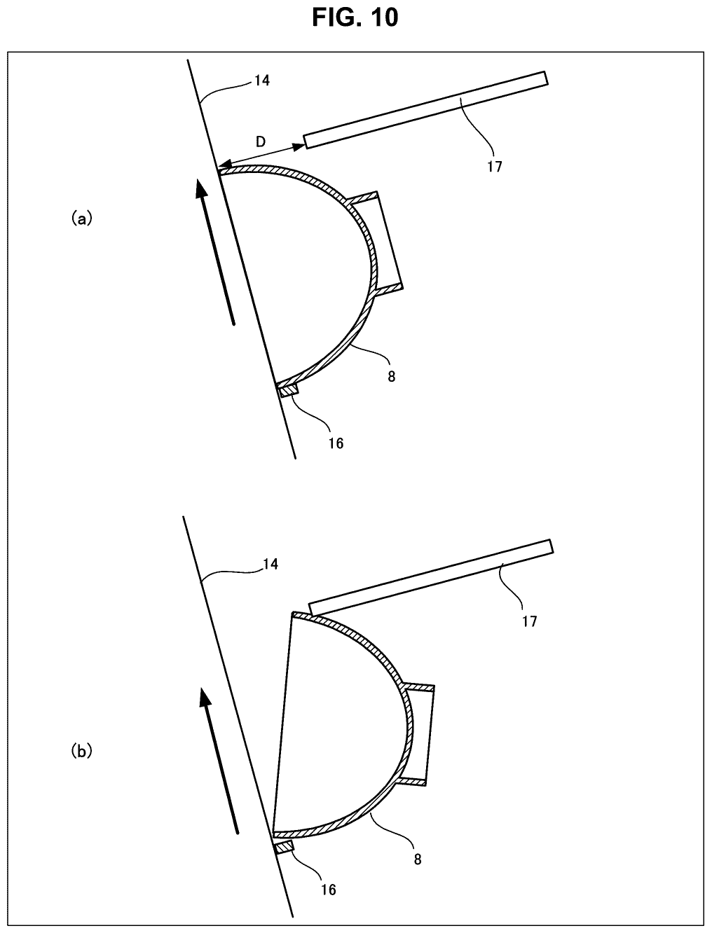

As shown in FIG. 10, the removing member 17 is a rod-shaped member extending from the front side of the endless belt 14 toward the surface of the endless belt 14. A distance D between the removing member 17 and the surface of the endless belt 14 is longer than a height of the first plate 7 and shorter than a height of the second plate 8. Therefore, the first plate 7 supported by the protrusion 16 does not contact the removing member 17, but the second plate 8 supported by the protrusion 16 contacts the removing member 17 and is detached from the endless belt 14.

Next, the guide member 18 will be described. Since the endless belt 14 of the conveyor device 1 moves while changing its direction by 180 degrees, the first plate 7 also changes its direction by 180 degrees while following this, and falls behind the conveyor device 1. Therefore, since rotational force is imparted from the endless belt 14 to the first plate 7, there is a risk that the first plate 7 may not be correctly introduced into the aligning device 2 to be described later due to its momentum. Accordingly, in this embodiment, as shown in FIG. 7, the guide member 18 is provided. The guide member 18 has a function of guiding the falling direction of the first plate 7 so that the first plate 7, which has passed over the upper end of the second portion 102, falls downward behind the second portion 102 when being detached from the endless belt 14.

The guide member 18 is, for example, a plate-shaped member arranged to extend along the conveyance direction of the endless belt 14 near the upper end of the conveyor device 1, so that the first plate 7 is guided to fall in a predetermined direction after being detached from the endless belt 14. Specifically, the guide member 18 is disposed such that the first plate 7 falls toward the aligning device 2. Thus, the first plate 7 lifted by the conveyor device 1 can be reliably guided into the aligning device 2.

### <3. Aligning Device>

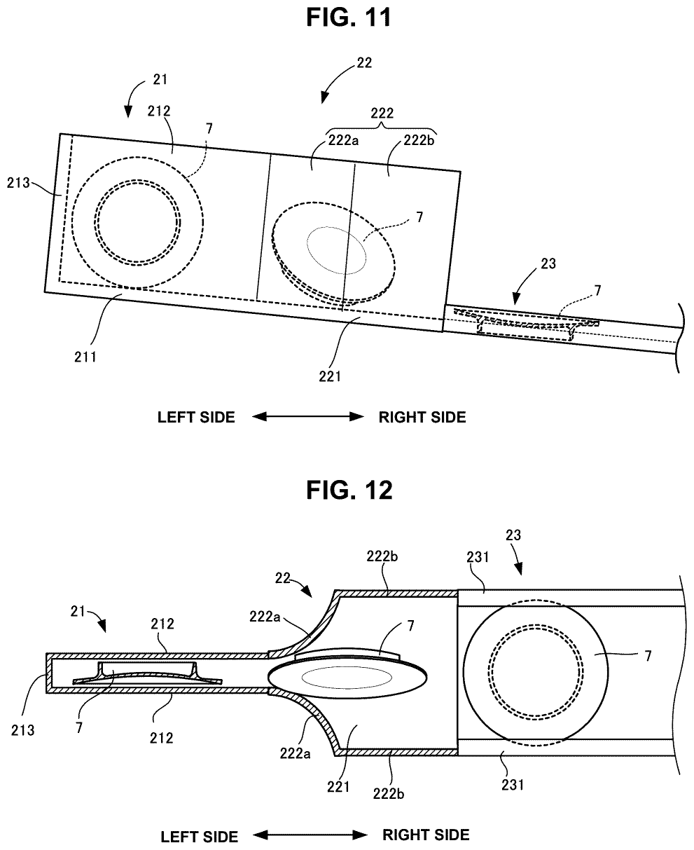

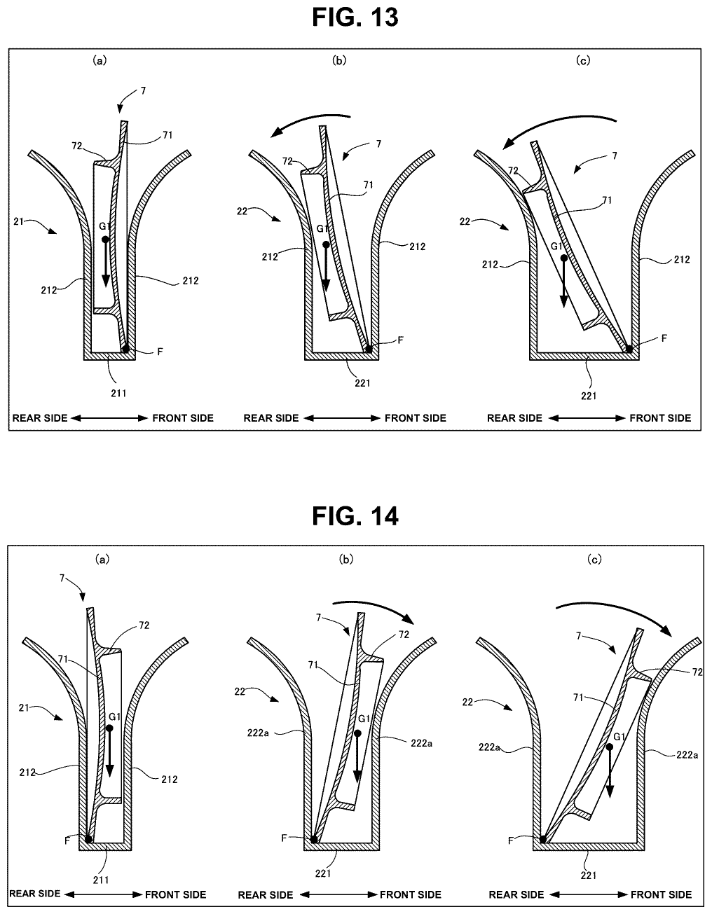

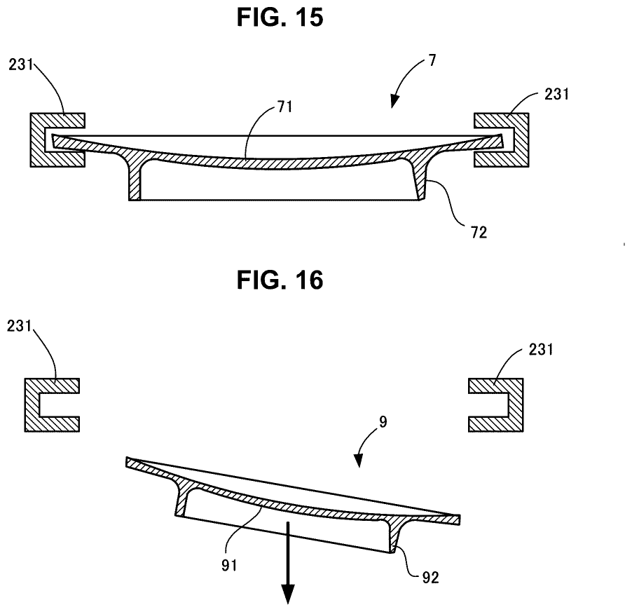

Next, the aligning device will be described with reference to FIGS. 11 to 16. FIG. 11 is a plan view of the aligning device, FIG. 12 is a side view of FIG. 11, FIGS. 13 and 14 are sectional views showing a mechanism of alignment, and FIGS. 15 and 16 are sectional views of a third passage of the aligning device. The aligning device 2 is a device for aligning the first plates 7 conveyed by the conveyor device 1 so that the upper surface of the body 71 of the plate faces upward, and for feeding them into a cleaning device 3 described later.

As shown in FIG. 11, the aligning device 2 extends so as to be inclined downward from the rear side of the conveyor device 1 toward the right side, and includes a first passage 21 provided behind the conveyor device 1, a second passage 22 connected to the first passage 21, and a third passage 23 connected to the second passage 22. The first plates 7 passing through the first to third passages 21 to 23 are fed into the cleaning device 3. On the other hand, as will be described later, the third plates 9 are removed from the aligning device 2 in the third passage 23.

### <3-1. First Passage>

As shown in FIGS. 11 and 12, the first passage 21 is provided behind the conveyor device 1 and below an upper end of the conveyor device 1. That is, the first plates 7 that have fallen downward by the guide member 18 described above are introduced therein. More specifically, the first passage 21 includes a first bottom surface 211 extending in the left-right direction, a pair of first side surfaces 212 rising from both sides (front and rear ends) of the first bottom surface 211, and an end wall 213 rising from an upstream side (left side) end of the first bottom surface 211. A width (front-rear width) of the first bottom surface 211 is slightly larger than a height of the first plate 7, and the first plate 7 introduced from between the pair of first side surfaces 212 is accommodated in the first passage 21 so that a radial direction thereof faces downward. Upper end portions of the pair of first side surfaces 212 are curved so as to be apart from each other. Thus, the first plate 7 falling from the conveyor device 1 can be easily introduced into the first passage 21. In addition, since the first bottom surface 211 is inclined downward toward the right side, the introduced first plate 7 moves by its own weight toward the second passage 22 on the right side. It is preferable that the width of the first bottom surface 211 be within twice the height of the first plate 7, and more preferably within 1.5 times. The width only needs to be such that the downward movement of the first plate 7 is not hindered by frictional force due to contact between the first plate 7 and the pair of first side surfaces 212.

### <3-2. Second Passage>

As shown in FIGS. 11 and 12, the second passage 22 includes a second bottom surface 221 continuous with the first bottom surface 211 of the first passage 21, and a pair of second side surfaces 222 continuous with the respective first side surfaces 212. The second bottom surface 221 is continuous with the first bottom surface 211 and is inclined downward toward the right side. Each of the second side surfaces 222 includes a first portion 222a connected to the first side surface 212, and a second portion 222b connected to the right side of the first portion 222a. The first portion 222a rises from both sides of the second bottom surface 221 and is curved so as to be apart from each other toward the lower side (right side). The pair of second portions 222b are arranged at a spacing slightly larger than an outer diameter of the first plate 7. The second bottom surface 221 is formed in a shape connecting the pair of second side surfaces 222. The first plate 7 that has passed through the second passage 22 is placed on the second bottom surface 221 in such a manner that an upper surface of the plate body 71 faces upward, as will be described later.

### <3-3. Third Passage>

As shown in FIGS. 11 and 12, the third passage 23 is constituted by a pair of guide rails 231. That is, the pair of guide rails 231, each having a U-shaped cross section, are arranged with an opening thereof facing each other and spaced apart in the horizontal direction. An outer edge portion of the plate body 71 of the first plate 7 is inserted into the opening of each guide rail 231. Therefore, the first plate 7 moves downward while being supported by the pair of guide rails 231. The first plate 7 is guided through the third passage 23 to an inlet 311 of the cleaning device 3 described later.

The configuration of each guide rail 231 is not limited to the above, and may be any form as long as it allows the first plate 7 to move downward while being supported.

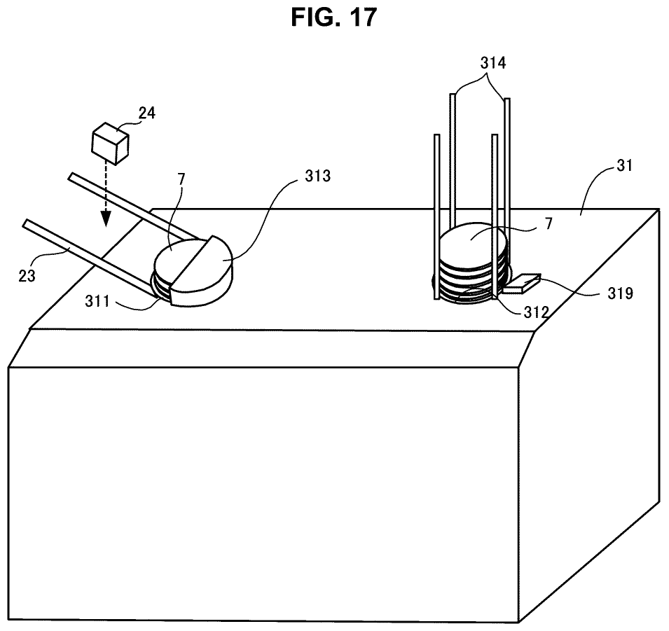

Further, as shown in FIG. 17 to be described later, a sensor 24 such as a photoelectric sensor is provided at a lower end portion of the third passage 23, and is configured to detect a time during which the first plate 7 passes through the sensor 24. In this embodiment, 0.2 seconds is set as one example of a threshold value (predetermined value). When the time during which the first plate 7 passes through the sensor 24 exceeds 0.2 seconds, it is determined that the first plate 7 is staying near the lower end of the third passage 23, and the conveyor device 1 is controlled to stop. Thereafter, when the time during which the first plate 7 passes through the sensor 24 becomes within 0.2 seconds, it is determined that the staying of the first plate 7 has been resolved and that the first plate 7 is smoothly supplied to the cleaning device 3, and the driving of the conveyor device 1 is restarted.

### <3-4. Behavior of the First Plate Passing Through the Aligning Device>

When the first plate 7 is introduced from the conveyor device 1 into the first passage 21, as shown in FIG. 13, there is a case where the plate body 71 is positioned at the front side, and as shown in FIG. 14, there is a case where the plate body 71 is positioned at the rear side. As shown in FIG. 13 (a), in the case where the plate body 71 is positioned at the front side in the first passage 21, the first plate 7 is in contact with a portion near a connecting portion between an outer edge of the plate body 71 and the first bottom surface 211 and the first side surface 212 on the front side. In addition, a center of gravity G1 of the first plate 7 is positioned at the rear side relative to the center in the width direction of the first passage 21. At this time, the first plate 7 moves from the first passage 21 to the second passage 22. Since the second passage 22 becomes wider toward the lower side, when the first plate 7 moves through the second passage 22, as shown in FIGS. 13 (b) and 13 (c), due to the action of the center of gravity G1, the first plate 7 tilts toward the second side surface 222 on the rear side with a contact portion between the plate body 71 and the second bottom surface 221 as a fulcrum F. Then, after passing through the first portion 222a of the second passage 22 and entering the second portion 222b, the foot 72 faces downward, and the first plate 7 descends in a state where an upper surface of the plate body 71 faces upward.

On the other hand, as shown in FIG. 14 (a), in the case where the plate body 71 is positioned at the rear side in the first passage 21, the first plate 7 is in contact with a portion near a connecting portion between an outer edge of the plate body 71 and the first bottom surface 211 and the side surface portion 212 on the rear side. In addition, a center of gravity G1 of the first plate 7 is positioned at the front side relative to the center in the width direction of the first passage 21. The first plate 7 moves from the first passage 21 to the second passage 22. Since the second passage 22 becomes wider toward the lower side, when the first plate 7 moves through the second passage 22, as shown in FIGS. 14 (b) and 14 (c), due to the action of the center of gravity G1, the first plate 7 tilts toward the second side surface 222 on the front side with a contact portion between the plate body 71 and the second bottom surface 221 as a fulcrum F. Then, after passing through the first portion 222a of the second passage 22 and entering the second portion 222b, the foot 72 faces downward, and the first plate 7 descends in a state where an upper surface of the plate body 71 faces upward.

As described above, when the first plate 7 is introduced into the first passage 21, regardless of whether the plate body 71 faces the front side or the rear side, when the first plate 7 enters the second portion 222b, the foot 72 faces downward, and the upper surface of the plate body 71 faces upward. In this manner, the first plate 7, whose vertical orientation has been adjusted, moves toward the third passage 23 at intervals. The third plate 9 also enters the third passage 23 by the same behavior.

As shown in FIG. 15, the first plate 7 moves downward while being supported by the guide rails 231 in the third passage 23, and is sequentially supplied to an inlet 311 of the cleaning device 3.

As described above, the third passage 23 is constituted by a pair of guide rails 231 arranged with a spacing therebetween. Since the spacing between the pair of guide rails 231 is set in accordance with the first plate 7, it is larger than an outer diameter of the third plate 9. Therefore, as shown in FIG. 16, the third plate 9 introduced into the third passage 23 falls downward through the spacing between the pair of guide rails 231. Thus, in the process where the first plate 7 and the third plate 9 pass through the aligning device 2, the third plate 9 is removed, and only the first plate 7 is supplied to the cleaning device 3. In addition, foreign matter other than the first plate 7, such as garbage, also falls through the spacing between the pair of guide rails 231, thereby preventing such foreign matter from entering the cleaning device 3.

### <4. Cleaning Device>

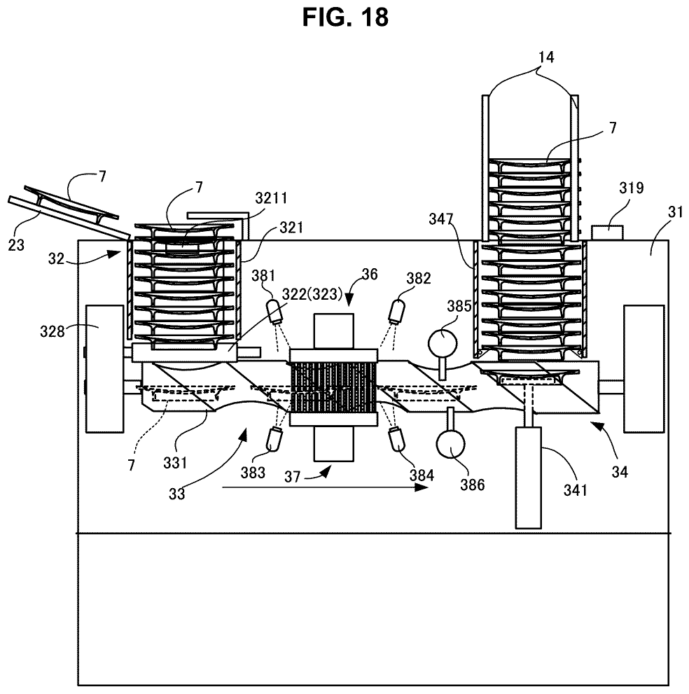

Next, the cleaning device will be described. FIG. 17 is a perspective view of the cleaning device, and FIG. 18 is a sectional view of the cleaning device.

As shown in FIGS. 17 and 18, the cleaning device 3 includes a casing 31, a supply portion 32, a conveying portion 33, and a discharge portion 34 for the first plates 7 provided in the casing 31, and first and second brush units 36 and 37 for cleaning the first plates 7. In this cleaning device 3, the first plates 7 supplied from the aligning device are supplied in a stacked state into the inside of the casing 31 by the supply portion 32. The supplied first plates 7 are conveyed in alignment by the conveying portion 33 inside the casing 31, and are cleaned by the pair of brush units 36 and 37 during the conveyance. The cleaned first plates 7 are discharged in a stacked state to the outside of the casing 31 by the discharge portion 34. Hereinafter, each configuration will be described in detail.

### <4-1. Casing>

As shown in FIG. 17, the casing 31 is formed in a rectangular parallelepiped shape, and a circular inlet 311 and a circular outlet 312 are formed at intervals on an upper surface thereof. The inlet 311 is an opening for supplying the first plates 7 into the casing 31, and is formed in a circular shape in accordance with the shape of the first plates 7. On the other hand, the outlet 312 is an opening for discharging the first plates 7 cleaned inside the casing 31 to the outside of the casing 31, and is also formed in a circular shape in accordance with the shape of the first plates 7, similar to the inlet 311. The first plates 7 discharged from the third passage 23 of the aligning device 2 are supplied to the inlet 311. Therefore, in the inlet 311, a region on the side opposite to the third passage 23 is covered with a guide cover 313. Thus, the first plates 7 supplied from the third passage 23 are guided by the guide cover 313 and introduced into the inlet 311.

On the other hand, along the periphery of the outlet 312, a plurality of support rods 314 extending in the vertical direction are arranged at predetermined intervals. As described later, the first plates 7 after cleaning are discharged from the outlet 312 in a stacked state and are stacked within a space surrounded by the support rods 314. Accordingly, the plurality of stacked first plates 7 are supported by the support rods 314 so as not to collapse.

Further, a color sensor 319 is provided outside the outlet 312, and the number of the first plates 7 discharged from the outlet 312 and the color of the first plates 7 are detected thereby.

### <4-2. Supply Portion>

As shown in FIG. 18, the supply portion 32 is a portion that guides the first plates 7 introduced from the inlet 311 downward, and includes a guide 321 extending in the vertical direction, and a pair of receiving rollers 322 and 323 disposed below the guide 321. The guide 321 guides the first plates 7 downward while keeping them in a horizontal state, and is formed in a cylindrical shape along an outer shape of the first plates 7.

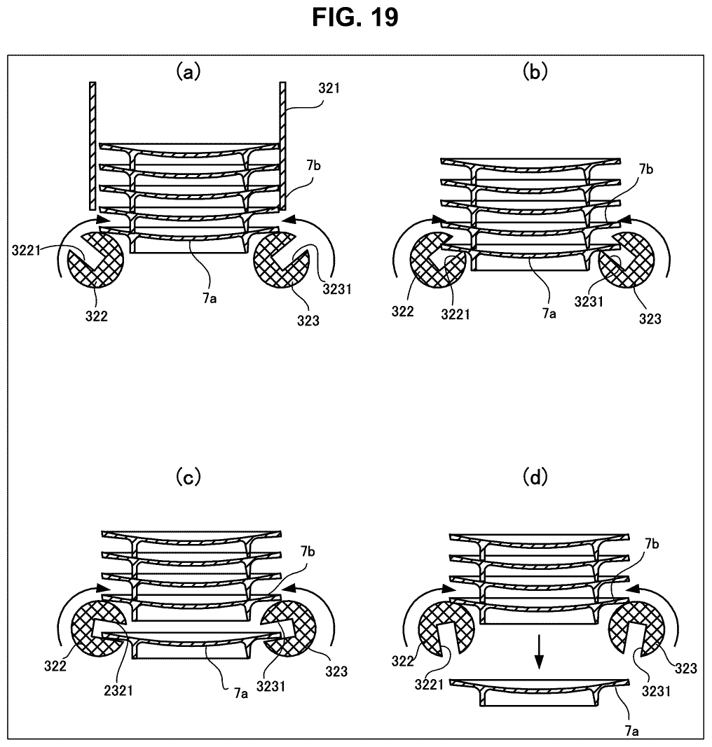

FIG. 19 is a diagram illustrating supply of the first plates 7. As shown in FIGS. 18 and 19, each receiving roller 322 and 323 is formed in a cylindrical shape and is rotatable around an axis extending in the horizontal direction. The receiving rollers 322 and 323 are connected to a motor (not shown) via a gear box 328, and are configured to rotate around the axis by the motor and the gear box 328. Further, as shown in FIG. 19, these receiving rollers 322 and 323 are configured to support a lower surface of the plate body 71 of the first plate 7. Specifically, the receiving rollers 322 and 323 are disposed at a spacing wider than an outer shape of the foot 72 of the first plate 7 and narrower than an outer shape of the plate body 71. In addition, on an outer peripheral surface of each receiving roller 322 and 323, grooves 3221 and 3231 extending in the axial direction are respectively formed, and the outer edge of the plate body 71 of the first plate 7 is fitted into the grooves 3221 and 3231.

Next, an operation of the supply portion 32 will be described. As shown in FIG. 19 (a), the first plates 7 introduced from the inlet 311 are guided downward in a stacked state by the guide 321, and the first plate 7a at the lowest position is supported by the receiving rollers 322 and 323. Accordingly, downward movement of the stacked first plates 7 is restricted. In this state, as shown in FIG. 19 (b), when the receiving rollers 322 and 323 rotate so as to face each other, the grooves 3221 and 3231 of the receiving rollers 322 and 323 fit with the outer edge of the plate body 71 of the first plate 7a at the lowest position. Then, as the receiving rollers 322 and 323 further rotate, as shown in FIG. 19 (c), while supporting the plate body 71 of the first plate 7b at the second lowest position from below, the receiving rollers 322 and 323 move the outer edge of the lowest first plate 7a downward by holding it with the grooves 3221 and 3231. Therefore, as shown in FIG. 19 (d), only the lowest first plate 7a can be moved downward by the receiving rollers 322 and 323. That is, the supply portion 32 intermittently moves the first plates 7 downward at predetermined time intervals.

Further, as shown in FIG. 18, a sensor 3211 is attached near an upper end of the guide 321, and is configured to detect the first plates 7 passing through the guide 321. When the stacked first plates 7 move downward and the first plates 7 can no longer be detected, the control device stops driving of the cleaning device 3 (at least stopping the supply portion 32, the conveying portion 33, the discharge portion 34, the brush units 36 and 37, and water spraying, etc.). Thereafter, when the first plates 7 are supplied to the supply portion 32 and the sensor 3211 detects the first plates 7, the control unit 5 restarts driving of the cleaning device 3.

### <4-3. Conveying Portion>

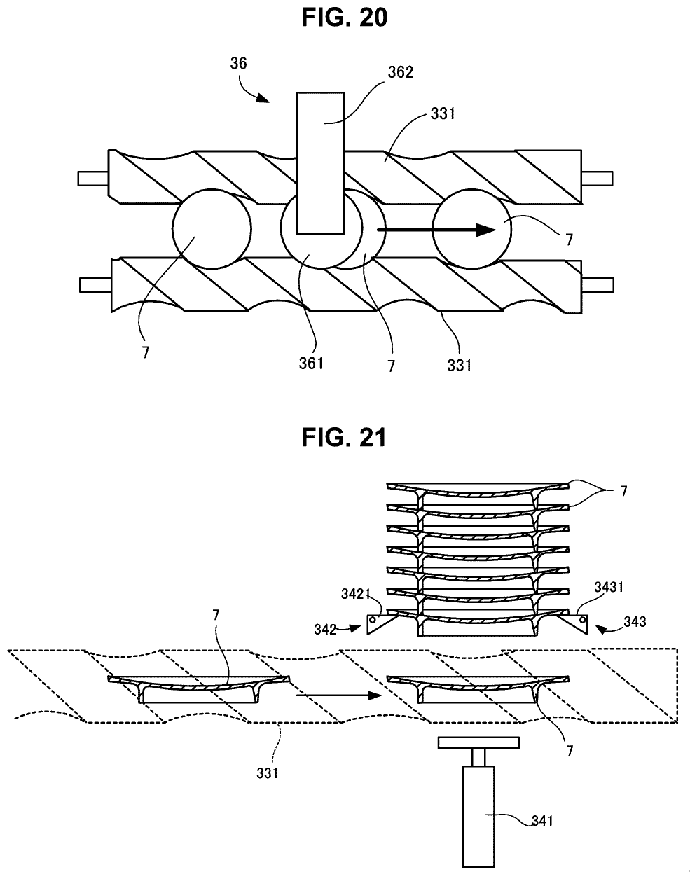

As shown in FIGS. 18 and 20, the first plates 7 moved downward by the supply portion 32 are conveyed horizontally (to the right side) by the conveying portion 33. More specifically, the conveying portion 33 includes a pair of known conveying screws 331 arranged in parallel at a predetermined interval in the horizontal direction. Each conveying screw 331 has a first end portion and a second end portion, and is rotatable around an axis extending in the horizontal direction. The first end portions of the conveying screws 331 on the supply portion 32 side are connected to a motor via the above-described gear box 328, and are configured to rotate around the axis by the motor and the gear box 328. Between the conveying screws 331, the first plates 7 moved downward from the supply portion 32 are arranged at predetermined time intervals. As shown in FIG. 20, while being supported by the conveying screws 331, the first plates 7 are conveyed horizontally toward the discharge portion 34. Accordingly, the conveying screws 331 convey the first plates 7 one by one in the horizontal direction at predetermined intervals.

### <4-4. Discharge Portion>

As shown in FIGS. 18 and 21, the discharge portion 34 includes a pusher 341 disposed on the second end portion side of the conveying screws 331, a pair of stoppers 342 and 343 disposed above the pusher 341 to restrict downward movement of the first plates 7, and a guide 347 extending in the vertical direction. The pusher 341 is disposed below the conveying screws 331 and is configured to move up and down between the conveying screws 331. Thus, the pusher 341 pushes the first plates 7 supported by the conveying screws 331 upward. The pusher 341 can be driven, for example, by an air cylinder. The first plate 7 pushed upward passes between the pair of stoppers 342 and 343, and is then supported by the stoppers 342 and 343. The guide 347 guides the first plates 7 upward while keeping them in a horizontal state, and is formed in a cylindrical shape along an outer shape of the first plates 7.

In more detail, each of the stoppers 342 and 343 is formed in a triangular prism shape of a right triangle in side view, and is rotatable around an axis extending in the horizontal direction. Each of the stoppers 342 and 343 has support surfaces 3421 and 3431 for supporting a lower surface of the plate body 71 of the first plate 7, similar to the above-described receiving rollers 322 and 323. The pair of stoppers 342 and 343 are arranged at a spacing wider than an outer shape of the foot 72 of the first plate 7 and narrower than an outer shape of the plate body 71. However, rotational shafts 3422 and 3432 of the stoppers 342 and 343 are disposed outside the first plate 7.

Each of the stoppers 342 and 343 is configured to rotate between a first position in which the support surfaces 3421 and 3431 are positioned above to support the plate body 71, and a second position in which the stoppers 342 and 343 are rotated upward around the axis (in the direction of arrow Y1) from the first position so that the first plate 7 can pass between the stoppers 342 and 343. The second position is a position where the support surfaces 3421 and 3431 are rotated by about 45 to 80 degrees. However, the stoppers 342 and 343 do not rotate downward from the first position. Further, when the first plate 7 passes between the stoppers 342 and 343 and no force acts on the stoppers 342 and 343 in the second position, each stopper 342 and 343 returns to the first position due to an imbalance of its center of gravity.

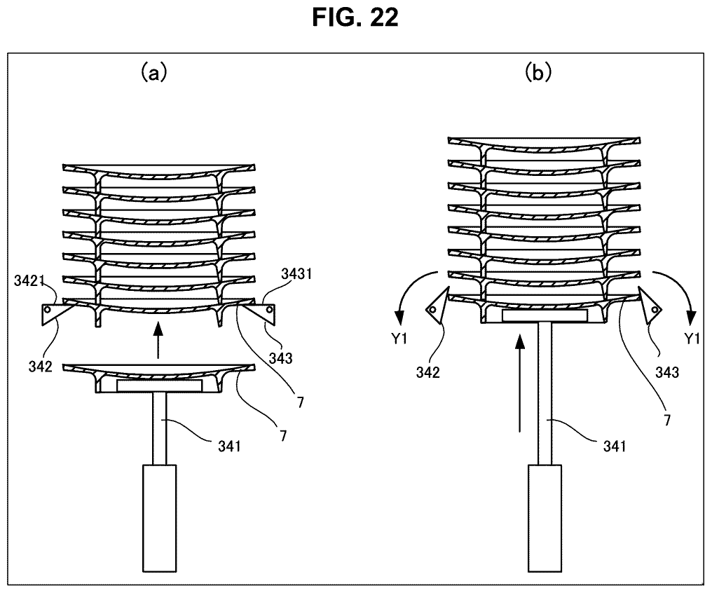

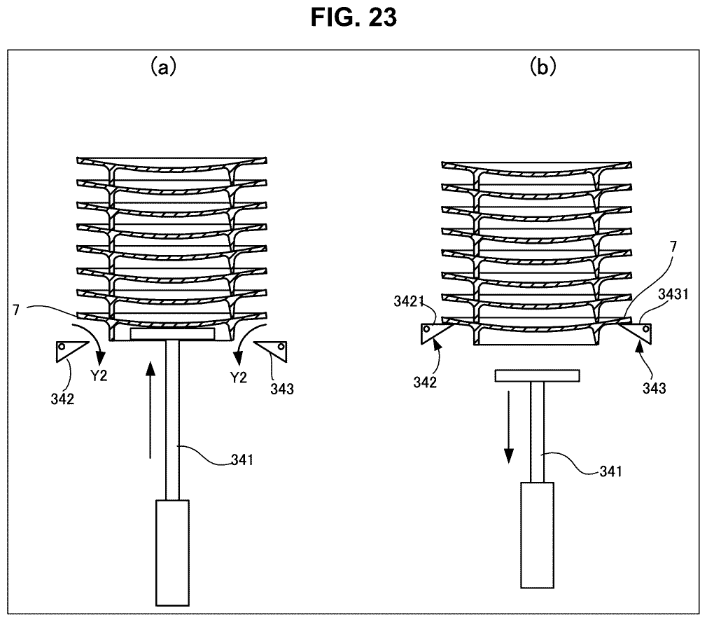

Next, discharge of the first plate 7 will be described with reference to FIGS. 22 and 23. As shown in FIG. 22 (a), when the stoppers 342 and 343 are in the first position, the support surfaces 3421 and 3431 support the first plate 7. In this state, when the first plate 7 on the conveying screw 331 is pushed upward by the pusher 341 and presses the stoppers 342 and 343 upward from below, as shown in FIG. 22 (b), the stoppers 342 and 343 rotate to the second position in the direction of arrow Y1, and the first plate 7 pushed upward passes between the stoppers 342 and 343. Then, as shown in FIG. 22 (c), when the first plate 7 pushed upward passes between the stoppers 342 and 343 and no force acts on the stoppers 342 and 343, the stoppers 342 and 343 rotate back to the first position in the direction of arrow Y2. Thereafter, as shown in FIG. 22 (d), when the pusher 341 descends, the first plate 7 that has passed between the stoppers 342 and 343 also descends, and is supported by the stoppers 342 and 343 in the first position. In this manner, the first plates 7 are stacked on the stoppers 342 and 343.

### <4-5. First and Second Brush Units>

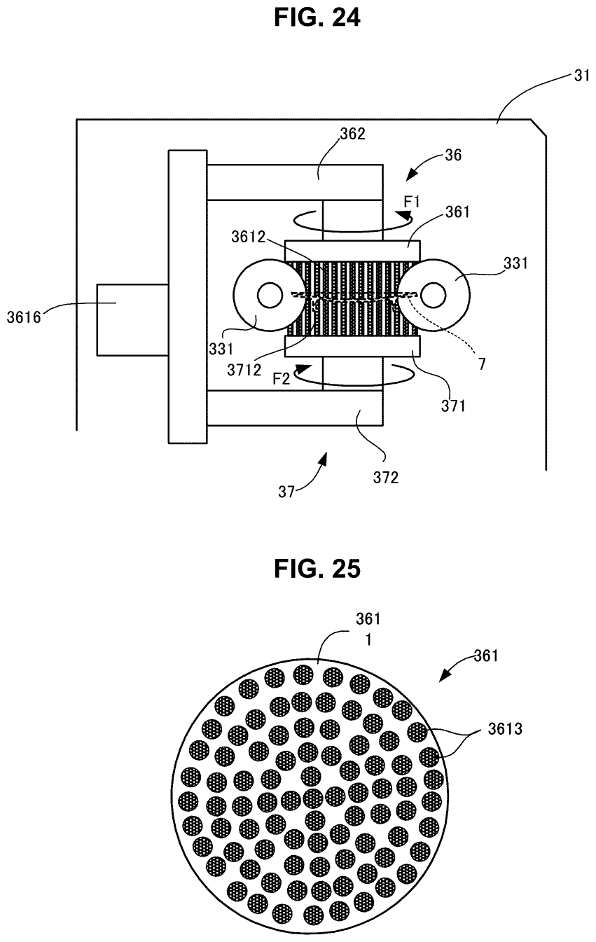

Next, the brush units will be described with reference also to FIGS. 24 and 25. As shown in FIGS. 18 and 24, the first brush unit 36 is disposed above the conveying portion 33, and is configured to clean an upper surface of the first plate 7 moving through the conveying portion 33. On the other hand, the second brush unit 37 is disposed below the conveying portion 33, and is configured to clean a lower surface of the first plate 7 moving through the conveying portion 33.

The first brush unit 36 includes a first brush body 361 for cleaning an upper surface of the first plate 7, and a first support 362 for rotatably supporting the first brush body 361. A rotary shaft provided on the first support 362 extends in the vertical direction, and the first brush body 361 is attached to a lower end of the rotary shaft. The first brush body 361 includes a disk-shaped substrate (first supporting portion) 3611, and a plurality of bristles 3612 extending downward from a lower surface of the substrate 3611. The substrate 3611 is formed in a shape substantially the same as, or larger than, the upper surface of the plate body 71. Further, on the substrate 3611, a plurality of tufts 3613, in which a predetermined number of bristles 3612 are bundled, are arranged over the entire lower surface of the substrate 3611.

More specifically, as shown in FIG. 25, the plurality of tufts 3613 are arranged in a ring shape, and further arranged concentrically to cover the entire substrate 3611. Since the upper surface of the plate body 71 is concave toward the center, the tufts 3613 arranged near the center of the substrate 3611 are longer, and those closer to an outer edge of the substrate 3611 are slightly shorter. Thus, the tufts 3613 conform to the upper surface of the plate body 71, enabling appropriate cleaning. The material constituting the bristles 3612 is not particularly limited, and may be, for example, resin materials such as nylon, PET, or PE, or animal hair.

The first brush body 361 is disposed between the pair of conveying screws 331 described above, and cleans the upper surface of the first plate 7 conveyed by the conveying screws 331 by rotating while pressing the bristles 3612 against the upper surface of the first plate 7. Further, as shown in FIG. 24, the first brush body 361 is configured such that rotational driving force from a motor 3616 is transmitted via gears and shaft members (not shown) passing through the first support 362, thereby rotating the first brush body 361.

The second brush unit 37 is configured in the same manner as the first brush unit 36. The second brush unit 37 includes a second brush body 371 for cleaning a lower surface of the first plate 7, and a second support 372 for rotatably supporting the second brush body 371. A rotary shaft provided on the second support 372 extends in the vertical direction, and the second brush body 371 is attached to an upper end of the rotary shaft. The configuration of the second brush body 371 is substantially the same as that of the first brush body 361, except that bristles 3722 extend upward. Further, unlike the first brush body 361, the tufts 3613 of the second brush body 371 are shorter near the center of the substrate 3711 and slightly longer toward the outer edge of the substrate 3711.

Further, the second brush body 371 is disposed between the pair of conveying screws 331, and cleans a lower surface of the first plate 7 by rotating while pressing the bristles 3712 against the lower surface of the first plate 7 conveyed by the conveying screws 331. The second brush body 371 is also configured to rotate by transmitting rotational driving force from a motor (not shown) via gears and shaft members passing through the second support 372. However, the second brush body 371 is configured to rotate in a direction opposite to the first brush body 361.

### <4-6. Others>

Inside the casing 31, a plurality of injection portions for spraying cleaning water onto the first plates 7 passing through the conveying portion 33 are provided above and below the conveying portion 33. As shown in FIG. 18, in this embodiment, injection portions 381 and 382 are respectively provided on an upstream side and a downstream side of the first brush body 361 above the conveying portion 33, and are configured to spray cleaning water toward the upper surface of the first plate 7. Similarly, injection portions 383 and 384 are respectively provided on an upstream side and a downstream side of the second brush body 371 below the conveying portion 33, and are configured to spray cleaning water toward the lower surface of the first plate 7. Further, although not shown, upstream of the injection portions 381 to 384, injection portions for spraying detergent are provided.

Further, a pair of air nozzles 385 and 386 are provided between the downstream injection portions 382 and 384 and the discharge portion 34. The air nozzles 385 and 386 are respectively disposed above and below the conveying portion 33, and are configured to blow air onto the upper surface and the lower surface of the first plate 7 moving through the conveying portion 33. Thus, moisture adhering to the upper surface and the lower surface of the first plate 7 is blown off.

Each of the above-described portions is controlled by a control device. That is, the control device performs various controls for driving the cleaning device 3, such as turning on and off the power supply of the cleaning device 3, rotating the conveying screws 331, rotating the receiving rollers 322 and 323, and rotating the brush bodies 361 and 371.

In particular, the control device controls each of the brush bodies 361 and 371 to rotate forward and reverse at predetermined timings. As described above, in the supply portion 32, the sensor 3211 is configured to detect the first plates 7, and when the first plates 7 are no longer detected by the sensor 3211, the driving of the cleaning device 3 is stopped. Thereafter, when the first plates 7 are detected by the sensor 3211, the cleaning device 3 is restarted. The control device changes the rotational direction of each brush body 361 and 371 at the timing when the cleaning device 3 is restarted. For example, when the first brush body 361 is rotating forward (for example, in the F1 direction in FIG. 24) and the driving of the cleaning device 3 is stopped, the first brush body 361 is configured to rotate in the reverse direction (for example, the F2 direction opposite to the F1 direction in FIG. 24) when the cleaning device 3 is restarted. Thereafter, each time the cleaning device 3 is restarted, the first brush body 361 rotates in the direction opposite to that before the restart. This also applies to the second brush body 371, which is always configured to rotate in a direction opposite to the first brush body 361.

### <4-7. Operation of the Cleaning Device>

When the first plates 7 are introduced into the inlet 311 from the aligning device 2, the first plates 7 are stacked in the supply portion 32. As described above, the stacked first plates 7 are placed one by one on the conveying screws 331 of the conveying portion 33 and conveyed horizontally toward the discharge portion 34. In this process, detergent and water are sprayed onto upper and lower surfaces of the first plates 7. Further, the upper and lower surfaces of the first plates 7 are cleaned by the rotating brush bodies 361 and 371. After passing the brush bodies 361 and 371, water is sprayed onto the first plates 7, and moisture adhering thereto is blown off by air sprayed from the air nozzles 385 and 386.

Thereafter, the first plates 7 are pushed upward one by one by the pusher 341 and stacked above the stoppers 342 and 343. As a plurality of the first plates 7 are thus stacked, the stacked first plates 7 are discharged outside the casing 31 from the outlet 312. Thereafter, the first plates 7 are transferred by a transfer device 6, which will be described next, to a conveyance path for the first plates 7.

### <5. Transfer Device>

### <5-1. Structure of Transfer Device>

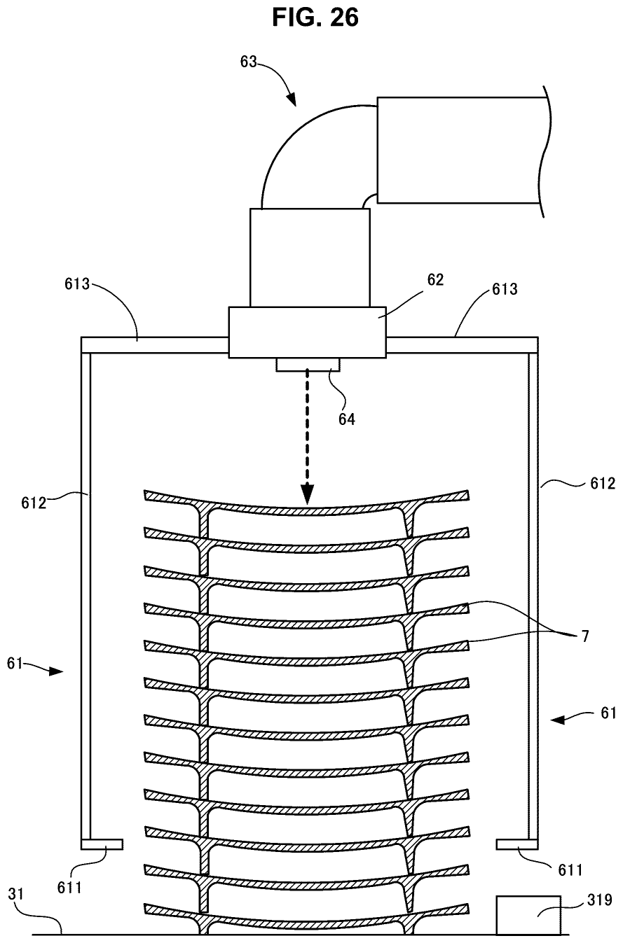

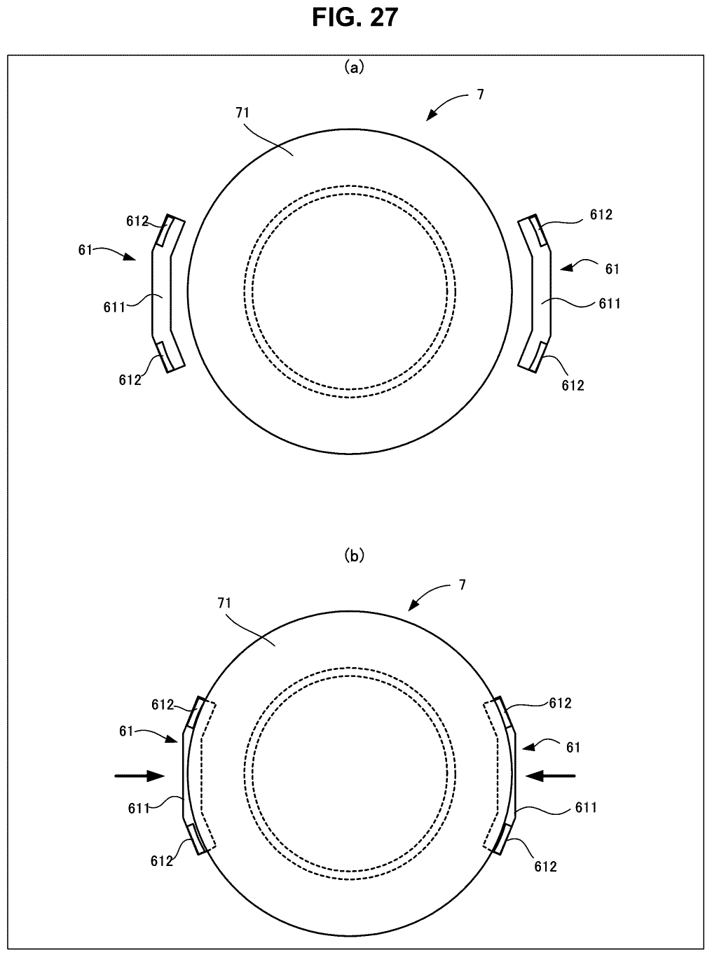

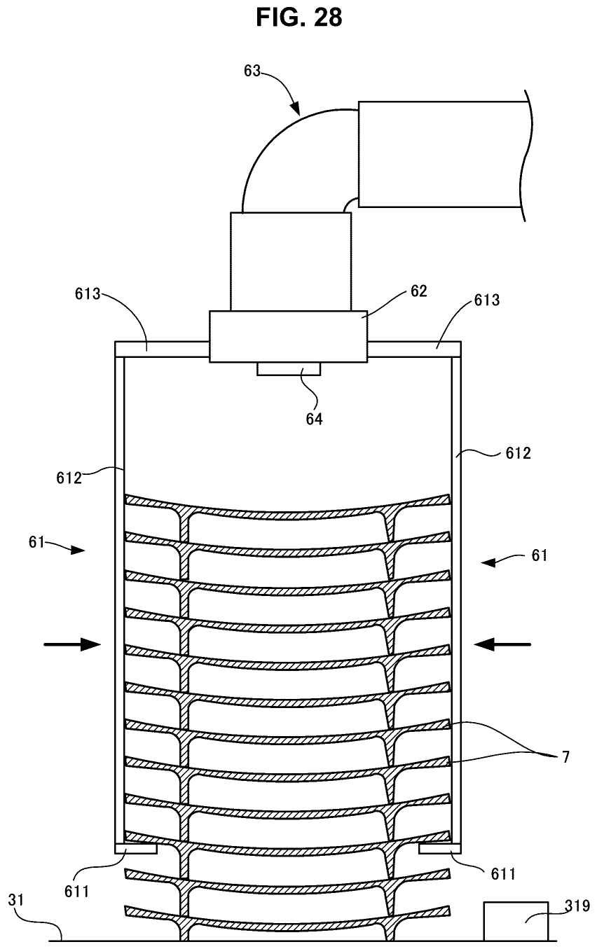

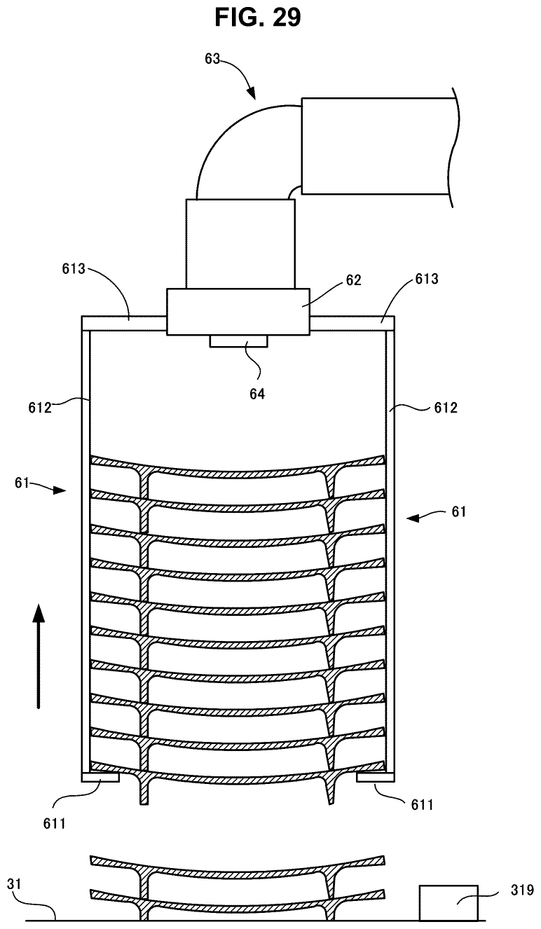

Next, the transfer device will be described with reference to the drawings. FIG. 26 is a side view of the transfer device, FIG. 27 is a plan view showing a positional relationship between a support portion of the transfer device and the first plate, and FIGS. 28 and 29 are side views illustrating an operation of the transfer device. The transfer device 6 is a device for transferring the washed first plate to a conveyance path.

As shown in FIG. 27, the transfer device 6 includes a pair of support units 61 that support the first plate 7, an adjustment portion 62 that adjusts a horizontal distance between the pair of support units 61, and a robot arm 63 that moves the adjustment portion 62.

Each support unit 61 includes a plate-like support portion 611, a pair of elongated members 612 extending upward from both ends of the support portion 611, and a connecting portion 613 to which upper ends of the pair of elongated members 612 are connected. As shown in FIG. 27 (a), the support portion 611 is formed in an arc shape in plan view, and is disposed on a lower surface of an outer edge portion of a plate body 71 of the first plate 7. The elongated members 612 are formed in a plate shape, and are connected to outer edges of both ends of the support portion 611, respectively. Each elongated member 612 has an arc-shaped contact surface in contact with the outer edge of the plate body 71, and the contact surfaces of the pair of elongated members 612 are disposed at positions deviated by about 30 degrees from the center of the plate body 71. By providing the pair of support units 61 configured in this way, as shown in FIG. 27 (b), four contact surfaces contact the outer edge of the plate body 71, and further, the support portion 611 supports the lower surface of the outer edge portion of the plate body 71, so that the first plate 7 is configured to be lifted upward.

The adjustment portion 62 incorporates an actuator, and by this actuator, the connecting portions 613 of the respective support units 61 are configured to approach or separate from each other in the horizontal direction. Thus, each support unit 61 moves in the horizontal direction between a first position and a second position. As shown in FIG. 27 (a) and FIG. 26, in the first position where the pair of support units 61 are separated, the four contact surfaces are separated from the plate body 71, and the support portion 611 is also separated from the first plate 7 in the horizontal direction. On the other hand, as shown in FIG. 27 (b) and FIG. 28, in the second position, the pair of support units 61 are close to each other, and the four contact surfaces contact the outer edge of the plate body 71. Further, the adjustment portion 62 is movable in a three-dimensional space by the robot arm 63. Accordingly, by driving the robot arm 63, the pair of support units 61 and the first plate 7 move together with the adjustment portion 62.

Further, a sensor 64 is provided on a lower surface of the adjustment portion 62, and by this sensor 64, a distance between an uppermost first plate 7 discharged from the outlet 312 of the cleaning device 3 and the sensor 64 can be measured. Therefore, the robot arm 63 can position the support portion 611 at a position of the first plate 7 to be supported while measuring the distance to the uppermost first plate 7. The number of support units 61 is not particularly limited and may be three or more.

### <5-2. Operation of the Transfer Device>

The transfer device 6 can transfer the first plates 7 to the conveyance path 100 in various ways. First, with the pair of support units 61 moved to the first position, the robot arm 63 is driven, and the support units 61 are lowered from above so as to sandwich the stacked first plates 7. Then, the first plates 7 discharged from the outlet 312 are transferred to the conveyance path 100 in predetermined numbers.

For example, in order to transfer the first plates 7 in units of ten, while measuring a distance between the sensor 64 and the uppermost first plate 7, as shown in FIG. 26, the support portion 611 is positioned near a lower surface of the plate body 71 of the tenth first plate 7 from the top. At this time, the control device stops discharging of the first plates 7 from the cleaning device 3, and during this stoppage, drives the actuator of the adjustment portion 62 to move the pair of support units 61 to the second position as shown in FIG. 28. As a result, the pair of support units 61 approach each other, and the support portion 611 moves below the plate body 71. Subsequently, as shown in FIG. 29, the robot arm 63 is driven to lift the pair of support units 61 upward. As a result, ten first plates 7 are lifted upward from the cleaning device 3. When the pair of support units 61 are lifted upward, the cleaning device 3 resumes discharging the first plates 7.

Then, when a foot portion 72 of the lowermost first plate 7 comes into contact with the conveyance path 100 by driving of the robot arm 63, the actuator is driven to separate the pair of support units 61. Thus, the ten first plates 7 are transferred onto the conveyance path 100. Thereafter, the robot arm 63 is driven to lift the pair of support units 61 upward again, move the support units 61 near the outlet 312 of the cleaning device 3, and repeat the above-described operation.

As another transfer method, the color sensor 319 of the cleaning device 3 detects a number and a color of the first plates 7 discharged from the outlet 312. When it is detected that a predetermined number (for example, ten) of the first plates 7 of the same color have been discharged from the outlet 312, the tenth first plate 7 is supported together with the sensor 64 as described above, and transferred to the conveyance path 100.

Alternatively, irrespective of the number of the first plates 7, when it is detected that the color of the first plates 7 discharged from the outlet 312 has changed, the first plates 7 above the first plate 7 whose color has changed are transferred as described above. In this embodiment, since the first plates 7 of the same color have the same shape, the same-shaped first plates 7 are stacked on the conveyance path 100. Note that instead of the color sensor 319, a sensor capable of detecting the shape of the first plates 7 may be used to transfer only the stacked first plates 7 having the same shape.

### <6. Features>

The cleaning system configured as described above has the following effects.

(1) From the plates stored in the water tank 10, only the first plates 7 and the third plates 9 can be selected and lifted by the conveyor device 1.

(2) In the aligning device 2, the first plates 7 and the third plates 9 can be oriented so that the plate bodies face upward.

(3) In the aligning device 2, the third plates 9 can be dropped in the third passage 23, so that only the first plates 7 are conveyed to the cleaning device 3.

(4) The transfer device 6 can transfer a predetermined number of the first plates 7 or the first plates 7 of a predetermined color in a stacked state to the conveyance path 100.

### <7. Modifications>

While one embodiment of the present invention has been described above, the present invention is not limited thereto, and various modifications are possible without departing from the spirit thereof. The following modifications can be combined as appropriate.

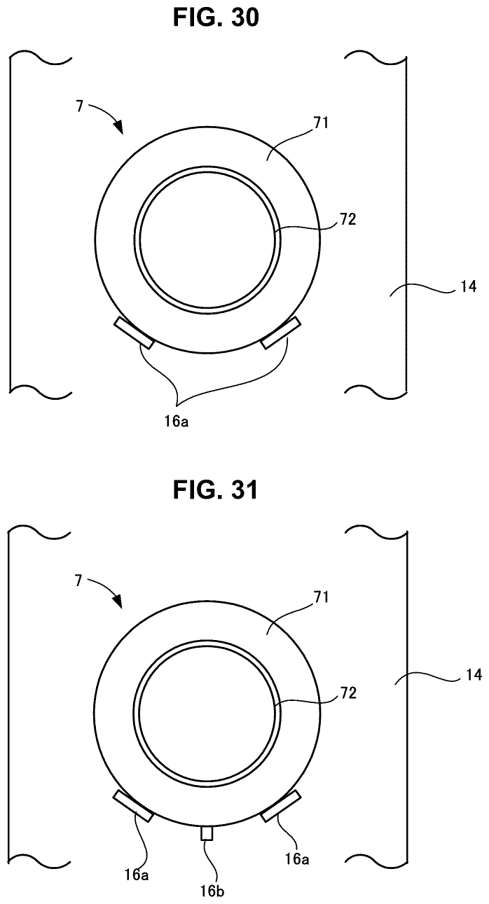

(1) The configuration of the protrusion 16 is not particularly limited, and as long as the first plates 7 can be supported, various modifications are possible. For example, as shown in FIG. 30, a plurality of protrusions 16a can be provided. Each protrusion 16a is formed of a plurality of plate members or projecting members, and the plurality of protrusions 16a can be arranged along an outer edge of the plate body 71 or a foot portion 72 of the first plate 7. In the example of FIG. 30, two protrusions of the same shape arranged symmetrically are provided.

As shown in FIG. 31, in addition to the protrusions 16a of FIG. 30, at least one protrusion 16b having a different shape can be provided between the protrusions 16a. These protrusions 16a and 16b can also be arranged along the outer edge of the plate body 71 or the foot portion 72 of the first plate 7.

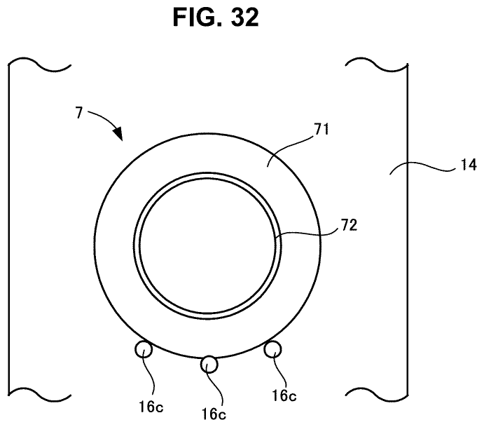

As shown in FIG. 32, a plurality of protrusions 16c having a circular shape in front view can be arranged along the outer edge of the plate body 71 or the foot portion 72 of the first plate 7. These protrusions 16c have the same shape.

As described above, the shape, position, and number of the protrusions are not particularly limited, and when the first plate 7 is supported by a plurality of protrusions, it is sufficient if the plurality of protrusions are arranged along an outer edge of the plate body 71 or a foot portion 72 of the first plate 7.

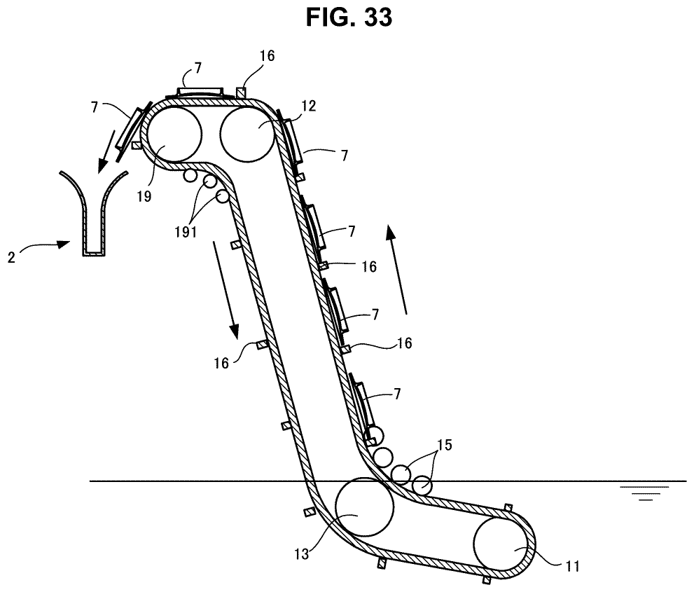

(2) In the conveyor device 1 of the above embodiment, the guide member 18 is provided so that the first plate falls toward the aligning device 2 from the upper end portion without inverting (see FIG. 5). For example, as shown in FIG. 33, the conveyor device 1 may be extended so that the first plate 7 conveyed to the upper end portion of the conveyor device 1 moves in the horizontal direction. In this example, at the upper end portion of the conveyor device, an additional rotating body 19 and a second pressing roller 191 for pressing a rear surface of the endless belt 14 are provided. With this configuration, the first plate 7 conveyed to the upper end portion of the conveyor device 1 is moved horizontally. Therefore, rotational force by the endless belt 14 as described above does not act on the first plate 7, and after moving horizontally, the first plate 7 can be correctly dropped toward the aligning device 2.

(3) In the above embodiment, the first to third plates 7 to 9 in the water tank 10 are conveyed by the conveyor device 1, and the second plates 8 are dropped into the water tank 10 during conveyance. However, it is sufficient if at least the first plates 7 and the second plates 8 are present in the water tank 10. Alternatively, plates other than the first to third plates 7 to 9 may be contained in the water tank 10. However, the conveyor device 1 of the present disclosure only needs to be configured to convey at least the first plates 7 and the second plates 8, and to drop the second plates 8 into the water tank 10 during conveyance.

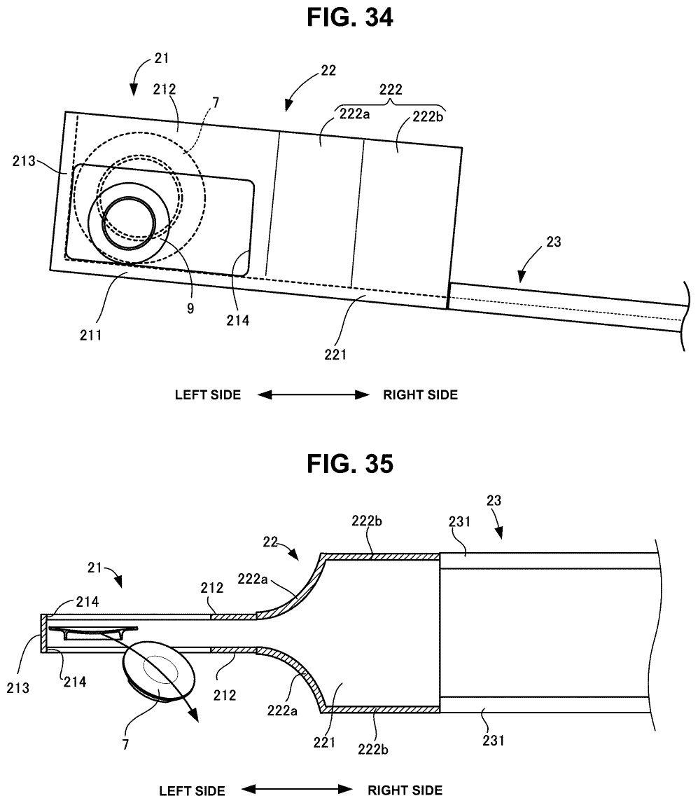

(4) In the aligning device 2 of the above embodiment, the third plates 9 are dropped in the third passage 23, but the third plates 9 may be dropped by another method. For example, as shown in FIGS. 34 and 35, openings 214 are formed in the first side portions 212 of the first passage 21, which are higher than an outer diameter of the third plates 9 and lower than an outer diameter of the first plates 7. The openings 214 are formed in a rectangular shape so as to extend upward from the first bottom portion 211, and a length in the lateral direction thereof is longer than the outer diameter of the third plates 9. Since the center of gravity G3 is located on the side of the foot portion 92 of the third plates 9, the third plates 9 tilt while passing through the first passage 21 and fall outside the first passage from one of the openings 214. Thus, the third plates 9 can be prevented from being introduced into the cleaning device 3. In this case, the third passage 23 having the above-described configuration becomes unnecessary, and it is sufficient if a passage for guiding the first plates 7 from the second passage 22 to the inlet 311 of the cleaning device 3 is provided.

(5) The configuration of the second passage 22 of the aligning device 2 is not particularly limited. For example, lengths of the first portion 222a and the second portion 222b may be changed as appropriate, and the side surface of the second passage 22 may be constituted only by the curved first portion 222a.

(6) In the aligning device 2, the above-described third passage or opening is not necessarily required, and for example, it is unnecessary when only the first plates are conveyed.

(7) The configurations of the aligning device 2, the conveyor device 1, the cleaning device 3, the transfer device 6, and the conveyance path 100 shown in the above embodiment are not particularly limited, and various modifications are possible as long as they have similar functions.

(8) In the above embodiment, the conveyor device 1 is used as part of the cleaning system, but it may also be used alone as a device for lifting plates accumulated in water. Further, in the above embodiment, the aligning device 2 is used as part of the cleaning system, but it may also be used alone as a device for aligning the orientation of the first plates 7 so that the plate bodies 71 face upward.

The present disclosure further includes the following technical aspects.

Frist aspect: An aligning device aligning plates each having a circular plate body and a foot provided on a lower surface of the plate body, the plate having a center of gravity at a position biased toward the foot, the aligning device comprising:
a first passage into which the plates are introduced; and
a second passage connected to the first passage, wherein
the first passage and the second passage are formed to extend obliquely from top to bottom in this order and to allow the plates to pass therethrough,
the first passage includes a first bottom surface having a width larger than a height of the plate, and a pair of first side surfaces rising from both sides of the first bottom surface,
the plate is introduced into the first passage from an upper side with a radial direction of the plate body extending downward,
the second passage includes a second bottom surface connected to the first bottom surface, and a pair of second side surfaces provided on both sides of the second bottom surface, and
the pair of second side surfaces have an interval therebetween that gradually widens downward.

Second aspect: The aligning device according to the first aspect, further comprising
a third passage connected to the second passage, wherein
the plates pass through the third passage after the second passage,
the third passage extends obliquely from top to bottom and includes a pair of guide rails spatially arranged with each other, and
the plate passes through the third passage while both sides of the plate body are being supported by the pair of guide rails of the third passage.

Third aspect: The aligning device according to the first aspect, wherein
upper ends of the pair of first side surfaces in the first passage are curved in different directions to be spaced away from each other.

Fourth aspect: The aligning device according to the first aspect, wherein
a sensor is provided in the third passage,
the sensor is configured to detect a passage time required for the plate to move for a predetermined distance in the third passage, and
when the detected passage time exceeds a predetermined value, the plates are prevented from being introduced into the first passage.

1. A conveyor device conveying upward, from a water tank, first plates among the first plates and second plates accumulated in the water tank, the conveyor device comprising:
a first rotating body disposed at a start end side of the conveyor device;
a second rotating body disposed at a terminal end side of the conveyor device;
an endless belt entrained between the first rotating body and the second rotating body; and
a plurality of protrusions provided on a surface of the endless belt and engageable with the first plates and the second plates, wherein
the conveyor device further comprises:
a first portion including the first rotating body and located mainly in water of the water tank; and
a second portion including the second rotating body and located mainly above the water of the water tank,
in the first portion, the endless belt is configured to move upward at a first angle with respect to a water surface of the water tank,
in the second portion, the endless belt is configured to move upward at a second angle larger than the first angle with respect to the water surface, and
in the second portion, the second angle is set such that
a virtual line extending vertically downward from a center of gravity of the first plate engaged with the protrusion intersects the surface of the endless belt within a region where the first plate is positioned, and
a virtual line extending vertically downward from a center of gravity of the second plate engaged with the protrusion intersects the surface of the endless belt outside a region where the second plate is positioned.

2. The conveyor device according to claim 1, wherein
each of the protrusions is formed in an arc-shape that is convex downward to receive the first plates.

3. The conveyor device according to claim 1, further comprising
a removing member separated away a predetermined distance from the surface of the endless belt in the second portion, wherein
the second plate is removed from the endless belt by the removing member when the second plate is brought into contact with the removing member.

4. The conveyor device according to claim 1, wherein
at an upper end of the second portion, the endless belt extends in a horizontal direction.

5. The conveyor device according to claim 1, further comprising
a guide member configured to guide an orientation of the first plate so that the first plate conveyed upward by the endless belt in the second portion falls in a predetermined direction downward when the first plate is removed from the endless belt near the upper end of the second portion.

6. The conveyor device according to claim 1, wherein
in the second portion, the second angle is set such that
the virtual line extending vertically downward from the center of gravity of the first plate engaged with the protrusion intersects the surface of the endless belt at a position above an engagement position between the first plate and the protrusion, and
the virtual line extending vertically downward from the center of gravity of the second plate engaged with the protrusion intersects the surface of the endless belt at a position below an engagement position between the second plate and the protrusion.

7. The conveyor device according to claim 1, further comprising
a pressing roller disposed between the first portion and the second portion, wherein
the pressing roller is configured to press the endless belt to change an angle of the endless belt between the first portion and the second portion.

8. The conveyor device according to claim 1, wherein
the endless belt extends linearly in plan view from a lower end of the first portion to an upper end of the second portion.

9. The conveyor device according to claim 1, wherein
the water tank is connected to a downstream end of a plate collection water channel laid in an interior of a restaurant for collecting the first plates and the second plates, and
the first plates and the second plates conveyed by the plate collection water channel are accumulated in the water tank.

10. The conveyor device according to claim 1, further comprising
a cleaning device configured to receive the first plates and clean the first plates.

11. The conveyor device according to claim 10, further comprising
a transfer device configured to transfer one or more first plates of the first plates to a conveying path extending to a kitchen in a restaurant, wherein
the transfer device includes a robot arm configured to:
hold the one or more first plates of the first plates that were cleaned by the cleaning device;
move the one or more first plates above the conveying path; and
release the one or more first plates on the conveying path.

12. A conveyor device conveying first plates accumulated in a water tank upward from the water tank, the conveyor device comprising:
a first rotating body disposed at a starting end side of the conveyor device;
a second rotating body disposed at a terminal end side of the conveyor device;
an endless belt entrained between the first rotating body and the second rotating body; and
a plurality of engaging portions provided on a surface of the endless belt and engageable with the first plates; wherein
the conveyor device further comprises:
a first portion including the first rotating body and located mainly in water of the water tank; and
a second portion including the second rotating body and located mainly above the water of the water tank,
in the first portion, the endless belt is configured to move upward at a first angle with respect to a water surface of the water tank, and
in the second portion, the endless belt is configured to move upward at a second angle larger than the first angle with respect to the water surface of the water tank.

13. The conveyor device according to claim 12, wherein
the conveyor device is configured to convey upward the first plates among the first plates and second plates accumulated in the water tank,
the plurality of engaging portions are provided on the surface of the endless belt and are engageable with the first plates and the second plates, and
a removing member is provided in the second portion to remove the second plate moving upward on the endless belt at the second angle from the endless belt.

14. The conveyor device according to claim 12, further comprising
a cleaning device configured to receive the first plates and clean the first plates.

15. The conveyor device according to claim 14, further comprising
a transfer device configured to transfer one or more first plates of the first plates to a conveying path extending to a kitchen in a restaurant, wherein
the transfer device includes a robot arm configured to:
hold the one or more first plates of the first plates that were cleaned by the cleaning device;
move the one or more first plates above the conveying path; and
release the one or more first plates on the conveying path.
